(19) United States
(12) Patent Application Publication
(10) Pub. No.: US 2015/0279420 A1
(43) Pub. Date: Oct. 1, 2015

(54) SIGNAL-QUALITY-INFORMATION CORRECTION DEVICE, SIGNAL-QUALITY-INFORMATION CORRECTION METHOD, AND INFORMATION REPRODUCTION SYSTEM

(71) Applicant: Panasonic Corporation, Osaka (JP)

(72) Inventors: Hisae Kato, Osaka (JP); Takeharu Yamamoto, Osaka (JP)

(21) Appl. No.: 14/361,508

(22) PCT Filed: Sep. 27, 2013
(86) PCT No.: PCT/JP2013/005790

§ 371 Date: May 29, 2014

(30) Foreign Application Priority Data
Oct. 1, 2012 (JP) 2012-219329

(51) Int. Cl. G11B 20/18; G11B 27/36

(52) U.S. Cl. CPC G11B 20/1816; G11B 27/36; G11B 2020/183

(57) ABSTRACT

Measured signal quality information obtained by measuring signal quality information showing signal quality obtained when an information reproduction device reproduces information from an information recording medium includes a device-caused variation which is a variation in the signal quality information that has degraded due to the information reproduction device, and a medium-caused variation which is a variation in the signal quality information that has degraded due to the information recording medium. A signal-quality-information correction device includes a device-caused-variation detection section which detects the device-caused variation included in the measured signal quality information, and a signal-quality-information correction section which corrects the measured signal quality information to signal quality information resulting from removal of the device-caused variation detected by the device-caused-variation detection section from the measured signal quality information.

### TECHNICAL FIELD

The present invention relates to a signal-quality-information correction device which corrects signal quality information showing signal quality obtained when an information reproduction device reproduces information from an information recording medium, a signal-quality-information correction method, and an information reproduction system, and particularly to the detection of degradation of the information recording medium.

### BACKGROUND ART

In recent years, as a result of the enforcement of the Product Liability Act (PL Act), the Financial Instruments and Exchange Act (J-SOX Act), and the like, companies are held liable for storing the electronic data held thereby for a long period of time. This causes a demand for an archive device capable of storing data (information) for a long period of time. As such archive devices, archive devices using optical discs represented by DVD (Digital Versatile Disc) and BD (Blu-ray (registered trademark) Disc) have drawn attention.

Each of the optical discs mentioned above has a longer lifetime inherent thereto and a long-period information storage property superior to that of a hard disc or a magnetic tape. In addition, an optical disc is a portable medium and can be attached/detached to/from a drive device which performs recording/reproduction to/from the optical disc. Accordingly, when the optical disc has degraded, by rewriting the information recorded on the optical disc to another optical disc and changing the optical discs, an archive device can be used continuously for a long period of time. Likewise, when the drive device in the archive device has degraded, by replacing the drive device, the archive device can be used continuously for a long period of time.

As described above, the archive device using the optical disc is excellent in long-period information storage, but has a problem in that, due to its use environment, use frequency, or the like, the optical disc or the drive device degrades and, in worst cases, the information recorded on the optical disc cannot be read any longer. That is, since the record mark formed on the optical disc degrades due to its storage environment, use environment, use frequency, or the like, the quality of a signal (signal quality) reproduced by the drive device degrades and, in worst cases, the information recorded on the optical disc cannot be read any longer.

On the other hand, in the drive device, due to its use environment, use situation, or the like, the degradation of laser characteristics, dust deposition, the degradation of a transmission path which transmits a reproduced signal, the degradation of a spindle motor which rotates an optical disc, or the like occurs. As a result, the quality of a reproduced signal degrades even though the record mark at a level allowing reproduction without any trouble using a drive device that has not degraded is formed on the optical disc. In worst cases, the information recorded on the optical disc cannot be read any longer.

When the optical disc has degraded, by rewriting the information recorded on the degraded optical disc to another optical disc that has not degraded and changing the optical discs, the information recorded on the optical disc can be read. Likewise, when the drive device has degraded, by replacing the degraded drive device with another drive device that has not degraded, the information recorded on the optical disc can be read.

As described above, the causes of the inability to read the information recorded on the optical disc include those due to the degradation of the optical disc and those due to the degradation of the drive device. Depending on which one of the degradation of the optical disc and the degradation of the drive device is responsible for the inability to read the information from the optical disc, different countermeasures are to be taken. Accordingly, it is desired to be able to specify which one of the degradation of the optical disc and the degradation of the drive device has caused the degradation of the reproduced signal.

In addition, when an archive device is used in a company or the like, it is too late if information cannot be read from an optical disc any longer and the information is lost. Therefore, to prevent the dissipation of the information, it is desired to be able to specify the degree of degradation of the optical disc.

To meet the desire, as a method for determining which one of the optical disc and the optical disc drive device has caused the degradation, a method is disclosed in Patent Document 1 which compares the amount of reflected light from a disc in use to the amount of reflected light from a reference disc to determine whether or not the disc in use has been contaminated or whether or not the amount of a light beam has decreased.

On the other hand, as a method for specifying the degree of degradation of an optical disc, a method is disclosed in Patent Document 2 which obtains prediction information related to the lifetime of the optical disc using an index showing the amount of erroneously read information to predict the lifetime of the optical disc.

However, in Patent Document 1, what is specified is only the cause of the reduced amount of reflected light from the optical disc which is either the optical beam or the optical disc, and the degree of degradation of the optical disc is not specified.

In addition, since an optical disc is a portable medium, the optical disc may be attached to another drive device. For example, in such a case where the drive device is replaced due to the failure, performance degradation, or the like thereof, the optical disc may be attached to a different drive device.

In Patent Document 2, the lifetime prediction information of such an optical disc attached to a different drive device is corrected on the basis of the difference between a measured value and an estimated value given by an approximation formula. However, the measured value is a value including both the degradation effect of the optical disc and the degradation effect of the drive device. As a result, in such a case where the performance of the drive device is improved as a result of drive replacement, the measured value is improved.

At this time, when the lifetime prediction information is corrected in accordance with the improved measured value despite the degradation of the optical disc, the lifetime of the optical disc is predicted to be longer. As a result, a situation is encountered where, against the user's assumption that the optical disc has not come to the end of its life, information cannot actually be read and important information may be lost.

On the other hand, when the lifetime prediction information is corrected in accordance with an inferior measured value, the lifetime of the optical disc is predicted to be shorter even though the optical disc has not degraded. As a result, the user re-records the information to another optical disc to prevent the dissipation of the information even though the optical disc has not degraded and accordingly the information need not originally be re-recorded to the other optical disc. This leads to the waste of the optical disc. Note that the same situation is also encountered when the optical disc is attached to a low-performance drive device.

Patent Document 1: Japanese Patent Application Laid-open No. 2005-78701

Patent Document 2: Japanese Patent Application Laid-open No. 2007-80363

### SUMMARY OF THE INVENTION

The present invention solves the problems described above and an object thereof is to provide a signal-quality-information correction device, a signal-quality-information correction method, and an information reproduction system which allow more precise detection of the degradation of an information recording medium.

A signal-quality-information correction device according to an aspect of the present invention is a signal-quality-information correction device which corrects signal quality information showing signal quality obtained when an information reproduction device reproduces information from an information recording medium. Measured signal quality information obtained by measuring the signal quality information includes a device-caused variation which is a variation in the signal quality information that has degraded due to the information reproduction device, and a medium-caused variation which is a variation in the signal quality information that has degraded due to the information recording medium. The signal-quality-information correction device includes a device-caused-variation detection section which detects the device-caused variation included in the measured signal quality information, and a signal-quality-information correction section which corrects the measured signal quality information to signal quality information resulting from removal of the device-caused variation detected by the device-caused-variation detection section from the measured signal quality information.

A signal-quality-information correction method according to another aspect of the present invention is a signal-quality-information correction method which corrects signal quality information showing signal quality obtained when an information reproduction device reproduces information from an information recording medium. Measured signal quality information obtained by measuring the signal quality information includes a device-caused variation which is a variation in the signal quality information that has degraded due to the information reproduction device, and a medium-caused variation which is a variation in the signal quality information that has degraded due to the information recording medium. The signal-quality-information correction method includes a detection step of detecting the device-caused variation included in the measured signal quality information, and a correction step of correcting the measured signal quality information to signal quality information resulting from removal of the device-caused variation detected in the detection step from the measured signal quality information.

An information reproduction system according to still another of the aspects of the present invention includes an information reproduction unit, and a monitoring server. The information reproduction unit includes the information recording medium, and an information reproduction device which reproduces information from the information recording medium. The information reproduction device includes a reproduction section which reproduces the information from the information recording medium, a signal-quality-information measurement section which measures signal quality information showing signal quality obtained when the reproduction section reproduces the information from the information recording medium, and a measurement-result transmission section which transmits a measurement result including the signal quality information measured by the signal-quality-information measurement section to the monitoring server. Measured signal quality information which is the signal quality information measured by the signal-quality-information measurement section includes a device-caused variation which is a variation in the signal quality information that has degraded due to the information reproduction device, and a medium-caused variation which is a variation in the signal quality information that has degraded due to the information recording medium. The monitoring server includes a measurement-result reception section which receives the measurement result transmitted from the measurement-result transmission section and including the measured signal quality information, a device-caused-variation detection section which detects the device-caused variation included in the measured signal quality information received by the measurement-result reception section, and a signal-quality-information correction section which corrects the measured signal quality information to signal quality information resulting from removal of the device-caused variation detected by the device-caused-variation detection section from the measured signal quality information.

The configurations described above allow the measured signal quality information to be corrected to the signal quality information resulting from removal of the device-caused variation from the measured signal quality information. Therefore, it is possible to more precisely detect the degradation of the information recording medium.

### BRIEF DESCRIPTION OF THE DRAWINGS

FIG. 1 is a schematic view of showing a configuration of an information reproduction unit in Embodiment 1 of the present invention.

FIG. 2 is an illustrative view of PR equalization when a PRML signal processing method is used.

FIG. 3 is an illustrative view of maximum likelihood decoding when the PRML signal processing method is used.

FIG. 4 is a first illustrative view for detecting signal quality when the PRML signal processing method is used.

FIG. 5 is a second illustrative view for detecting signal quality when the PRML signal processing method is used.

FIG. 6 is a flow chart showing an example of a correction method for signal quality information in the information reproduction unit in Embodiment 1 of the present invention.

FIG. 7 is a set of views showing the relationships of a disc-caused variation and a device-caused variation with respect to reference signal quality information, reference-disc measured signal quality information, degradation-detection-target-disc measured signal quality information, and post-correction signal quality information.

FIG. 8 is a view showing the relationship between a MLSE and a variance.

FIG. 9 is a view showing the relationship between the square of the MLSE and the variance.

FIG. 10 is a view showing various measured values and post-correction MLSEs when the same degradation-detection target disc is subjected to degradation detection using two drive devices.

FIG. 11 is a schematic view showing a configuration of an information reproduction unit in Embodiment 2 of the present invention.

FIG. 12 is a flow chart showing an example of a correction method for signal quality information in an information reproduction unit in Embodiment 2 of the present invention.

FIG. 13 is a first view showing a change in reference-disc estimated signal quality information in the information reproduction unit in Embodiment 2 of the present invention.

FIG. 14 is a second view showing a change in the reference-disc estimated signal quality information in the information reproduction unit in Embodiment 2 of the present invention.

FIG. 15 is a view showing a first relationship between an approximation formula and an interpolation formula in the information reproduction unit in Embodiment 2 of the present invention.

FIG. 16 is a view showing a second relationship between the approximation formula and the interpolation formula in the information reproduction unit in Embodiment 2 of the present invention.

FIG. 17 is a flow chart showing another example of the correction method for signal quality information in the information reproduction unit in Embodiment 2 of the present invention.

FIG. 18 is a flow chart showing an example of a correction method for signal quality information in an information reproduction unit in Embodiment 3 of the present invention.

FIG. 19 is a schematic view showing a configuration of an information reproduction system in Embodiment 4 of the present invention.

FIG. 20 is a flow chart showing an example of a measurement method for signal quality information in the information reproduction unit in Embodiment 4 of the present invention.

FIG. 21 is flow chart showing an example of a correction method for signal quality information at a monitoring server in Embodiment 4 of the present invention.

### BEST MODE FOR CARRYING OUT THE INVENTION

Referring to the drawings, a description will be given below of each of the embodiments of the present invention.

### Embodiment 1

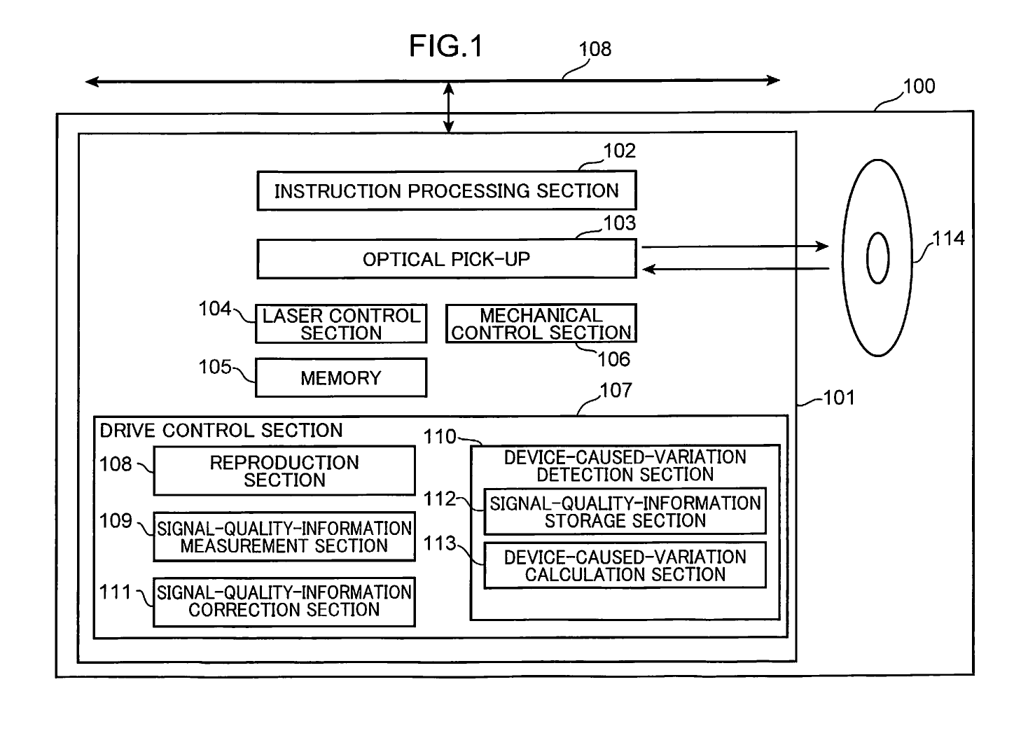

FIG. 1 is a view showing a configuration of an information reproduction unit in Embodiment 1 of the present invention. An information reproduction unit 100 includes a drive device 101 as an example of an information reproduction device which reproduces information from an information recording medium, and an optical disc 114 as an example of the information recording medium. The drive device 101 is connected to a higher-order control device (not shown) via an I/O bus (input/output bus) 108. For example, the higher-order control device is a host computer (host PC).

The drive device 101 includes an instruction processing section 102 which processes an instruction from the higher-order control device, an optical pick-up 103 which irradiates the optical disc 114 with a laser beam so as to reproduce information (data) therefrom, a laser control section 104 which controls the laser power output from the optical pick-up 103 and the like, a memory 105 which temporarily stores, as a buffer, the data reproduced from the optical disc 114 and the like, a mechanical control section 106 for performing servo control for the movement of the optical pick-up 103 to an intended position or the like, and a drive control section 107 in charge of controlling general drive processes such as a process of reproduction from the optical disc 114. Note that the optical disc 114 can be attached/detached to/from the drive device 101 and, to the drive device 101, another optical disc can be attached.

The drive control section 107 includes a reproduction section 108 which reproduces data from the optical disc 114, a signal-quality-information measurement section 109 which measures signal quality information showing signal quality obtained when the information is reproduced from the optical disc 114, a device-caused-variation detection section 110 which detects a device-caused variation included in measured signal quality information as the signal quality information measured by the signal-quality-information measurement section 109, and a signal-quality-information correction section 111 which corrects the measured signal quality information measured by the signal-quality-information measurement section 109 to signal quality information from which the device-caused variation, which is an output from the device-caused-variation detection section 110, has been removed. The device-caused-variation detection section 110 includes a signal-quality-information storage section 112 which stores the signal quality information, and a device-caused-variation calculation section 113 which calculates the device-caused variation.

The device-caused-variation detection section 110 and the signal-quality-information correction section 111 correspond to an example of a signal-quality-information correction device which corrects signal quality information showing signal quality obtained when the information reproduction device reproduces information from an information recording medium. Accordingly, the configurations of the device-caused-variation detection section 110 and the signal-quality-information correction section 111 are not particularly limited to the configurations in the present embodiment. Each of the device-caused-variation detection section 110 and the signal-quality-information correction section 111 may also be configured as a device separate from the drive device 101 or embedded in a monitoring server described later or the like. The same also applies to the other embodiments described later.

The configuration of the information recording/reproduction unit shown in FIG. 1 is only exemplary and is not limited thereto. Any configuration can be used as long as the same effects can be obtained therefrom. For example, the information recording/reproduction unit may also be configured to include a plurality of the optical discs. This allows large-capacity data to be recorded/reproduced. Alternatively, the information recording/reproduction unit may also include a plurality of the drive devices. This allows high-speed recording/reproduction. The information recording/reproduction unit may also include a changer which automatically attaches/detaches the optical disc to/from the drive device. This allows disc change without a manual operation and can reduce the load on a person. This can also reduce the time required for disc change.

The signal-quality-information measurement section 109 is configured to function independently of the reproduction section 108. However, it may also be possible to omit the signal-quality-information measurement section 109 and measure the signal quality information using the function or the reproduction section 108. The signal-quality-information measurement section 109 may also be configured to be provided in the reproduction section 108, acquire a necessary signal from the reproduction section 108, and process the acquired signal. The signal-quality-information storage section 112 is provided in the device-caused-variation detection section 110, but may also be configured independently of the device-caused-variation detection section 110 or configured independently of the drive control section 107.

Next, a description will be given of the signal quality information measured by the signal-quality-information measurement section 109. The signal quality information is an index for the evaluation of the performance of an optical disc. For example, information showing signal quality (measured values of signal quality) when reproduction from the optical disc is performed, such as modulation degree, beta, jitter, C/N, S/N, bit error rate, symbol error rate, MLSE (Maximum Likelihood Sequence Error), or i-MLSE (integrated-Maximum Likelihood Sequence error Estimation), can be used. It is assumed that, in the present embodiment, by way of example, a BD-R (Recordable) is used as the optical disc 114 to be subjected to degradation detection and the MLSE is used as the signal quality information.

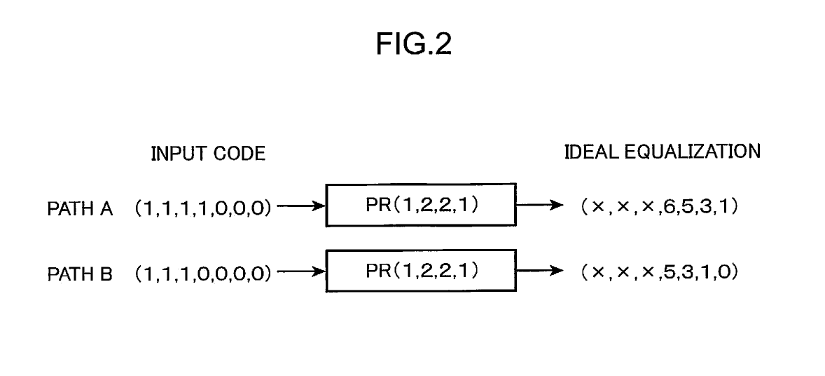

First, using FIGS. 2 to 5, a description will be given of the MLSE as the signal quality information. The MLSE is an index which shows signal quality when a PRML (Partial Response Maximum likelihood) signal processing method is used and which is one of the indices for the evaluation of the performance of the optical disc.

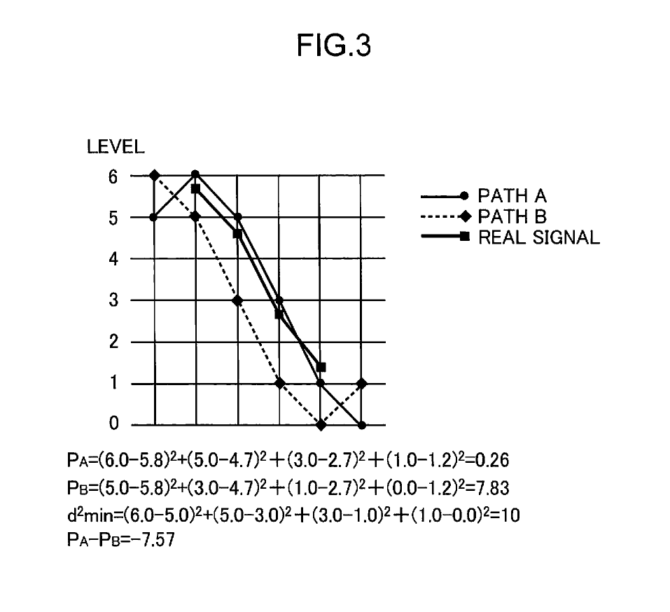

FIGS. 2 and 3 are illustrative views related to PR (Partial Response) equalization and maximum likelihood decoding when the PRML signal processing method is used. Here, a description will be given of the case where the encoding method used for the BD is (1,7)RLL and the PR method used therefor is a PR (1,2,2,1) method.

When the encoding method is the (1,7)RLL and the PR method is the (1,2,2,1) method, an ideal equalization signal has seven values of (0,1,2,3,4,5,6) and an input code and ideal equalization have such a relationship as shown in FIG. 2 therebetween. The path A corresponds to the case where the input code is (1,1,1,1,0,0,0) and the path B corresponds to the case when the input code is (1,1,1,0,0,0,0). When each of the input codes is equalized in accordance with the PR(1,2,2,1) method, the result of ideal equalization in the path A is (x,x,x,6,5,3,1) and the result of ideal equalization in the path B is (x,x,x,5,3,1,0).

Next, the process of the maximum likelihood decoding is shown in FIG. 3. The path A and the path B correspond to signal sequences when the ideal equalization shown in FIG. 2 is performed. It is assumed here that a real signal is an ideal signal to which noise has been added, and one of the paths A and B is selected as a path which is closer to the real signal. It is assumed here that, as the real signal, (x,x,x,5.8,4.7,2.7,1.2) has been obtained. The maximum likelihood decoding determines the code corresponding thereto.

In the case of FIG. 3, when the Euclidean distance P_{A} between the real signal and the path A and the Euclidean distance P_{R} between the real signal and the path B are calculated, P_{A} is 0.26 and P_{B} is 7.83. In this case, when a comparison is made between P_{A} and P_{B}, the Euclidean distance P_{A} is smaller and therefore the path A can be determined to be a most likely path. Accordingly, (1,1,1,1,0,0,0) is obtained from the code corresponding to the path A as a result of the maximum likelihood decoding.

This time, the maximum likelihood decoding has been performed on the basis of the result of calculating the Euclidean distances by regarding the real signal as the path A. Here, the basic concept of signal quality obtained when PRML signal processing is used is to determine the certainty with which the real signal has been regarded as the path A (or path B). For example, if P_{A}<P_{B} is satisfied, the path A can be selected with confidence and, if P_{A}>P_{B} is satisfied, the path B can be selected with confidence. As an index showing the certainty of the path selection, P_{A}−P_{B} is used. That is, if P_{A}−P_{B}=0, the chance of selecting each of the paths is fifty-fifty. If a value larger or smaller than a given value is provided, it can be said that the path selection is certain.

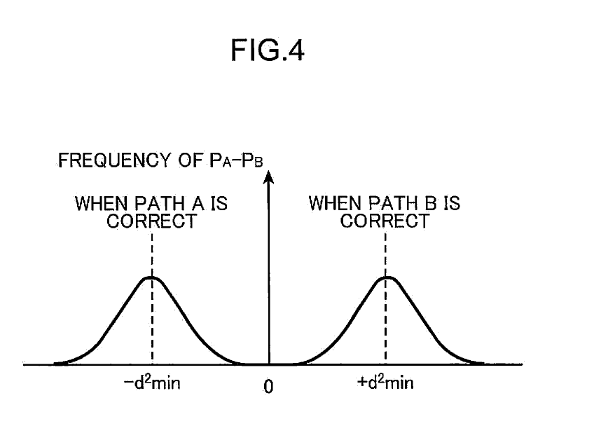

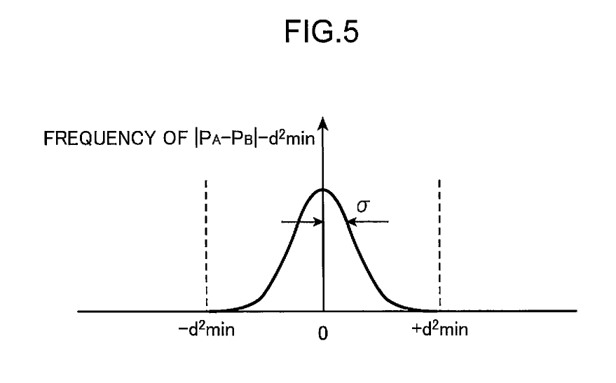

When it is assumed here that white noise is added to the real signal, the histogram shown by P_{A}−P_{B} corresponds to the sum of two normal distributions centered at the positive and negative values of d² min (minimum Euclidean distance) which are the Euclidean distances of the paths A and B, as shown in FIG. 4 (Frequency of P_{A}−P_{B}). However, in the current form, the sum of the two normal distributions is hard to handle when signal quality is determined. Accordingly, as shown in FIG. 5, the absolute value of P_{A}−P_{B} is determined and then a peak shift corresponding to d² min is caused to provide a distribution D (Frequency of |P_{A}−P_{B}|−d² min). The distribution D is given by Numerical Expression (1). Then, from the obtained distribution D, a standard deviation σ is obtained and normalized to provide a MLSE. As a result, a variance σ² showing dispersion from a mean value is given by Numerical Expression (2) and the MLSE is given by Numerical Expression (3). That is, the MLSE is the signal quality information represented by the standard deviation.

[Numerical Expression 1]

D=|P_{A}−P_{B}|=d² min (1)

[Numerical Expression 2]

σ²= D̅²̅− D̅²̅ (2)

$$\begin{matrix}[ Numerical Expression 3 ] & \\ MLSE = \frac{σ}{2 \cdot {d}^{2} min} & ( 3 )\end{matrix}$$

Next, a description will be given of the causes of degradation of signal quality information. In the optical disc 114 such as a BD, under the influence of its storage environment, use environment, use state, or the like such as, e.g., the use or storage of the optical disc 114 in a high-temperature environment or repeated recording/reproduction to/from the optical disc 114, the record mark recorded on the optical disc 114 or a recording film may degrade. Due to such degradation of the optical disc 114, the quality of the signal reproduced by the drive device 101 degrades to degrade the measured signal quality information.

In the drive device 101, in the same manner as in the optical disc 114, under the influence of its use environment, use state, or the like, the degradation of laser characteristics, the effect of dust, the degradation of a transmission path which transmits a reproduced signal, the degradation of a spindle motor which rotates the optical disc 114, or the like occurs. Due to such degradation of the drive device 101, the quality of a reproduced signal degrades to degrade the measured signal quality information.

Thus, the causes of degradation of the signal quality information include those due to the optical disc 114 and those due to the drive device 101 and the signal quality information that has been measured (measured signal quality information) includes a disc-caused variation (medium-caused variation) which is a variation in the signal quality information that has degraded due to the optical disc 114 and a device-caused variation which is a variation in the signal quality information that has degraded due to the drive device 101.

Accordingly, to precisely detect the degradation of the optical disc 114, it is necessary to correct the measured signal quality information to signal quality information including only the disc-caused variation (medium-caused variation) as the variation in the signal quality information that has degraded due to the optical disc 114 by removing the device-caused variation as the variation in the signal quality information that has degraded due to the drive device 101 from the measured signal quality information.

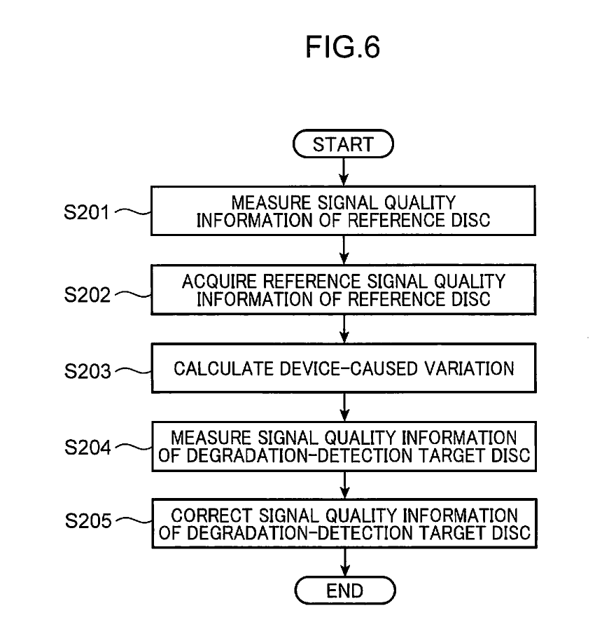

To satisfy the necessity, using FIGS. 6 to 10, a description will be given of a correction method for signal quality information in Embodiment 1 of the present invention.

In the correction method for signal quality information in the present embodiment, to detect the device-caused variation as the variation in the signal quality information that has degraded due to the drive device 101, a reference disc as an example of a reference information recording medium is used. The reference disc is an optical disc having known reference signal quality information. Here, the reference signal quality information is signal quality information in which the device-caused variation as the variation in the signal quality information that has degraded due to the drive device 101 is 0 and the disc-caused variation as the variation in the signal quality information that has degraded due to the reference disc is known.

It is assumed that, in the present embodiment, as the reference disc, a test disc manufactured for e.g., the inspection/measurement/adjustment of a BD drive is used. This is because, since it is guaranteed that the test disc has been subjected to recording compliant with a BD standard, the device-caused variation can be more precisely determined. It is also assumed that the reference disc used in the present embodiment is stored in a proper environment and has not degraded or the influence of degradation on the reference disc is ignorable. That is, it is assumed that the signal quality information of the reference disc does not include the disc-caused variation at any time and the disc-caused variation is 0.

Next, a method of obtaining the reference signal quality information of the reference disc will be described. In the reference signal quality information of the reference disc, the device-caused variation needs to be 0. Accordingly, the signal quality information of the reference disc is measured using a standard evaluation tool such as, e.g., ODU-1000 commercially available from Pulstec Industrial Co., Ltd. The measured signal quality information of the reference disc serves as the reference signal quality information. This is because, since the standard evaluation tool can measure the signal quality information in an optimal condition, the signal quality information does not deteriorate due to the standard evaluation tool. Consequently, the device-caused variation included in the measured signal quality information is 0 so that the signal quality information of the reference disc measured using the standard evaluation tool serves as the reference signal quality information.

The signal quality information measured using the standard evaluation tool does not also include the signal quality information which degrades due to an individual difference resulting from variations in the drive device 101 during the manufacturing thereof. Accordingly, by using the signal quality information measured using the standard evaluation tool as the reference signal quality information, it is possible to detect the device-caused variation including also the individual difference resulting from variations in the drive device 101 during the manufacturing thereof. Therefore, it is possible to detect a more precise device-caused variation.

In addition, since the device-caused variation in the signal quality information measured using the standard evaluation tool is 0, in such a case where, e.g., the drive device 101 is replaced with another drive device which is not brand-new, even when the drive device has already degraded when a measurement on the reference disc is started, the device-caused variation including a variation due to the already degraded drive device can be detected. Therefore, it is possible to detect a more precise device-caused variation.

Note that, since the reference signal quality information is in one-to-one correspondence with the reference disc, even when the drive device 101 is replaced with another drive device, the same reference signal quality information is used while the same reference disc is used. The reference signal quality information is stored in the signal-quality-information storage section 112 by the device-caused-variation detection section 110 before the device-caused variation is detected. For example, at the time of shipment of the drive device 101 from a factory, initial use of the drive device 101, or the like, the reference signal quality information is stored in the signal-quality-information storage section 112. As a result, the reference signal quality information to be used when the device-caused variation is detected can be acquired easily.

FIG. 6 is a flow chart showing the correction method for signal quality information in Embodiment 1 of the present invention. Using FIG. 6, the correction method for signal quality information will be described on the assumption that the optical disc to/from which a user records or reproduces data, i.e., the optical disc subjected to degradation detection is a degradation-detection target disc.

First, in Step S201, the device-caused-variation detection section 110 measures the signal quality information of the reference disc using the signal-quality-information measurement section 109. Specifically, when the reference disc is attached to the drive device 101, the device-caused-variation detection section 110 measures the signal quality information of the reference disc using the signal-quality-information measurement section 109. The signal-quality-information measurement section 109 controls the optical pick-up 103, the laser control section 104, and the mechanical control section 106 to irradiate the reference disc with a laser beam and obtain a reproduced signal. The device-caused-variation detection section 110 measures the signal quality information from the obtained reproduced signal. It is assumed here that the signal quality information obtained by measuring the reference disc is reference-disc measured signal quality information Ms.

Next, in Step S202, the device-caused-variation calculation section 113 acquires the reference signal quality information of the reference disc. Specifically, the device-caused-variation calculation section 113 acquires reference signal quality information Mi of the reference disc from the signal-quality-information storage section 112.

Next, in Step S203, the device-caused-variation calculation section 113 calculates the device-caused variation. Specifically, the device-caused-variation calculation section 113 calculates a device-caused variation Vc from the reference-disc measured signal quality information Ms obtained in Step S201 and the reference signal quality information Mi of the reference disc acquired in Step S202. Note that a specific calculation method will be described later.

Next, in Step S204, the signal-quality-information correction section 111 measures the signal quality information of the degradation-detection target disc using the signal-quality-information measurement section 109. Specifically, the degradation-detection target disc is attached to the drive device 101. When the degradation-detection target disc is attached, the signal-quality-information correction section 111 measures the signal quality information of the degradation-detection target disc using the signal-quality-information measurement section 109. The operation of the signal-quality-information measurement section 109 is the same as in Step S201 so that a description thereof is omitted. It is assumed here that the signal quality information obtained by measuring the degradation-detection target disc is degradation-detection-target-disc measured signal quality information Mm.

Next, in Step S205, the signal-quality-information correction section 111 corrects the signal quality information of the degradation-detection target disc. Specifically, the signal-quality-information correction section 111 removes the device-caused variation Vc obtained in Step S203 from the degradation-detection-target-disc measured signal quality information Mm obtained in Step S204 to correct the degradation-detection-target-disc measured signal quality information Mm. It is assumed here that the corrected degradation-detection-target-disc measured signal quality information is degradation-detection-target-disc corrected signal quality information M. Note that a specific correction method will be described later.

Here, in FIG. 6, the device-caused variation is calculated first and then the signal quality information of the degradation-detection target disc is measured. However, the time for measuring the signal quality information of the degradation-detection target disc is not particularly limited to this example. It is sufficient if the signal quality information of the degradation-detection target disc can be measured before the correction is performed in Step S205. The process of measuring the signal quality information of the degradation-detection target disc may also be performed before the signal quality information of the reference disc is measured. Alternatively, the process of measuring the signal quality information of the degradation-detection target disc may also be performed in parallel with the acquisition of the reference signal quality information of the reference disc or the calculation of the device-caused variation. This can reduce the time required for the process.

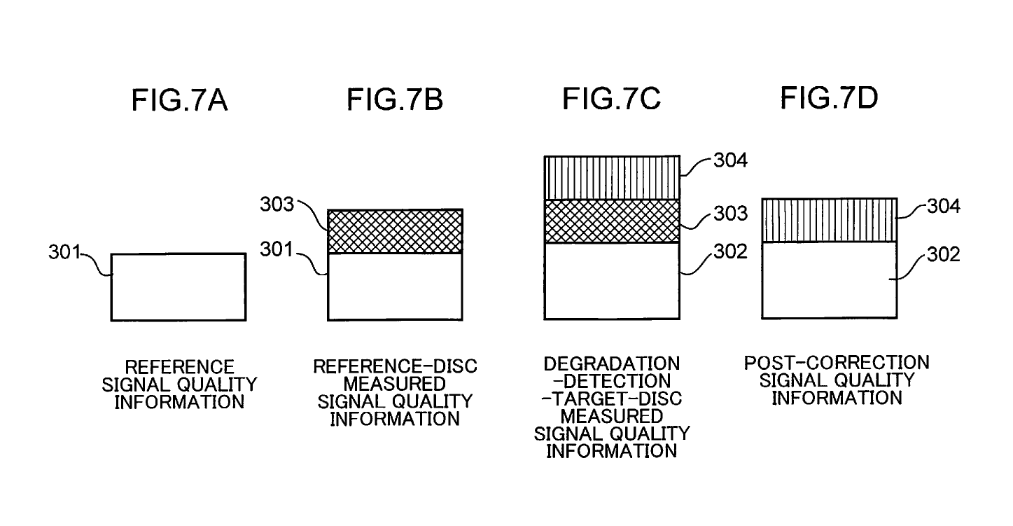

Next, a specific description will be given of a method of calculating the device-caused variation Vc in Step S203. FIG. 7 is a set of views showing the relationships of the disc-caused variation and the device-caused variation with respect to the reference signal quality information, the reference-disc measured signal quality information, the degradation-detection-target-disc measured signal quality information, and the degradation-detection-target-disc corrected signal quality information. Here, the disc-caused variation is a variation in the signal quality information that has degraded due to the degradation of the optical disc and the device-caused variation is a variation in the signal quality information that has degraded due to the degradation of the drive device.

The signal quality information shown in FIG. 7A is reference signal quality information 301 which includes neither the disc-caused variation nor the device-caused variation. The signal quality information shown in FIG. 7B is the reference-disc measured signal quality information which includes the reference signal quality information 301 and device-caused variation 303 due to the drive device 101. Note that, since the reference disc has not degraded, the disc-caused variation is not included therein. Accordingly, the device-caused variation 303 can be determined by the difference between the reference-disc measured signal quality information and the reference signal quality information.

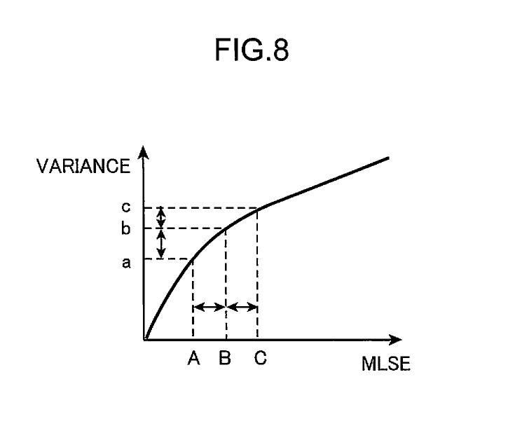

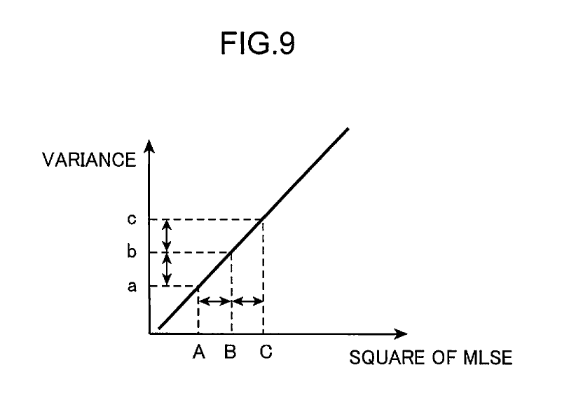

However, since the MLSE is represented by the standard deviation a which is the square root of the variance as in Numerical Expression (3), even though a MLSE difference is merely determined, the device-caused variation cannot be determined correctly. The reason for this will be described using FIGS. 8 and 9.

FIG. 8 is a view showing the relationship between the MLSE and the variance. In FIG. 8, the A-B MLSE variation and the B-C MLSE variation are same, but the a-b variance variation and the b-c variance variation are different. Accordingly, to correctly detect the device-caused variation, it is necessary to correctly detect a variation in the variance which shows dispersion from a mean value. Therefore, as shown in FIG. 9, when the MLSE is squared, the relationship between the square of the MLSE and the variance becomes linear. As a result, the a-b variance variation and the b-c variance variation become equal to each other to allow the variance variation to be detected correctly.

Therefore, as given by Numerical Expression (4), the device-caused variation Vc in Step S203 can be calculated by taking the square root of a value obtained by subtracting a value obtained by squaring the reference signal quality information Mi from a value obtained by squaring the reference-disc measured signal quality information Ms.

[Numerical Expression 4]

Vc=\sqrt{Ms²−Mi²} (4)

Next, a detailed description will be given of a correction method for the signal quality information of the degradation-detection target disc in Step S205. The signal quality information shown in FIG. 7C is the degradation-detection-target-disc measured signal quality information and includes an initial value 302 of the signal quality information of the degradation-detection target disc, a device-caused variation 303 due to the drive device 101, and a disc-caused variation 304 due to the degradation-detection target disc. The signal quality information shown in FIG. 7D is post-correction signal quality information, i.e., the degradation-detection-target-disc corrected signal quality information and includes the signal quality information obtained by removing the device-caused variation 303 from the degradation-detection-target-disc measured signal quality information, i.e., the initial value 302 of the signal quality information of the degradation-detection target disc and the disc-caused variation 304 due to the degradation-detection target disc.

Thus, the causes of degradation of the signal quality information include those due to the optical disc 114 and those due to the drive device 101. As shown in FIG. 7C, the measured signal quality information (degradation-detection-target-disc measured signal quality information) includes the disc-caused variation 304 due to the optical disc 114 and the device-caused variation 303 due to the drive device 101. Accordingly, to precisely detect the degradation of the optical disc 114, it is necessary to correct the measured signal quality information to signal quality information including only the disc-caused variation 304 as the signal quality information that has degraded due to the optical disc 114 by removing the device-caused variation 303 as the signal quality information that has degraded due to the drive device 101 from the measured signal quality information, as shown in FIG. 7D.

Consequently, the degradation-detection-target-disc corrected signal quality information M calculated in Step S205 corresponds to the signal quality information obtained by removing the device-caused variation Vc calculated in Step S203 from the degradation-detection-target-disc measured signal quality information Mm.

Here, to perform precise correction, even when the degradation-detection-target-disc corrected signal quality information M is obtained, as shown in Numerical Expression (5), a value obtained by squaring the device-caused variation Vc is subtracted from a value obtained by squaring the degradation-detection-target-disc measured signal quality information Mm and taking the square root of the resulting difference. Thus, the degradation-detection-target-disc corrected signal quality information M resulting from removal of the device-caused variation from the degradation-detection-target-disc measured signal quality information is obtained.

$$\begin{matrix}[ Numerical Expression 5 ] & \\ \begin{matrix}M = \sqrt{{Mm}^{2} - {Vc}^{2}} \\ = \sqrt[2]{{Mm}^{2} - {Ms}^{2} + {Mi}^{2}}\end{matrix} & ( 5 )\end{matrix}$$

As described above, by calculating the device-caused variation using the reference signal quality information of the reference disc and the measured signal quality information thereof and removing the device-caused variation from the measured signal quality information of the degradation-detection target disc, it is possible to correct the degradation-detection-target-disc measured signal quality information including the device-caused variation and the disc-caused variation to the signal quality information resulting from removal of the device-caused variation from the degradation-detection-target-disc measured signal quality information and obtain the degradation-detection-target-disc corrected signal quality information. That is, the signal quality information which is degraded only due to the optical disc can be obtained.

Accordingly, by using the corrected signal quality information (degradation-detection-target-disc corrected signal quality information) for detecting the degradation of the optical disc or predicting the lifetime thereof, it is possible to perform more precise degradation detection or more precise lifetime prediction for the optical disc. This can prevent a situation where important data is lost by determining that there is no degradation even though there is actually degradation or information is re-recorded to another optical disc by determining that there is degradation even though there is actually no degradation and such re-recording need not originally be performed, resulting in waste of the optical disc.

It has been assumed that, in Step S203, as the device-caused variation Vc, the square root of a value obtained by subtracting the value obtained by squaring the reference signal quality information from the value obtained by squaring the reference-disc measured signal quality information is taken. However, it may also be possible to hold the obtained value as the squared value without taking the square root thereof since the square root is squared again in Step S205. This can reduce a calculation process. This can also suppress a calculation error. In addition, since the variation is linear, a comparison can easily be made.

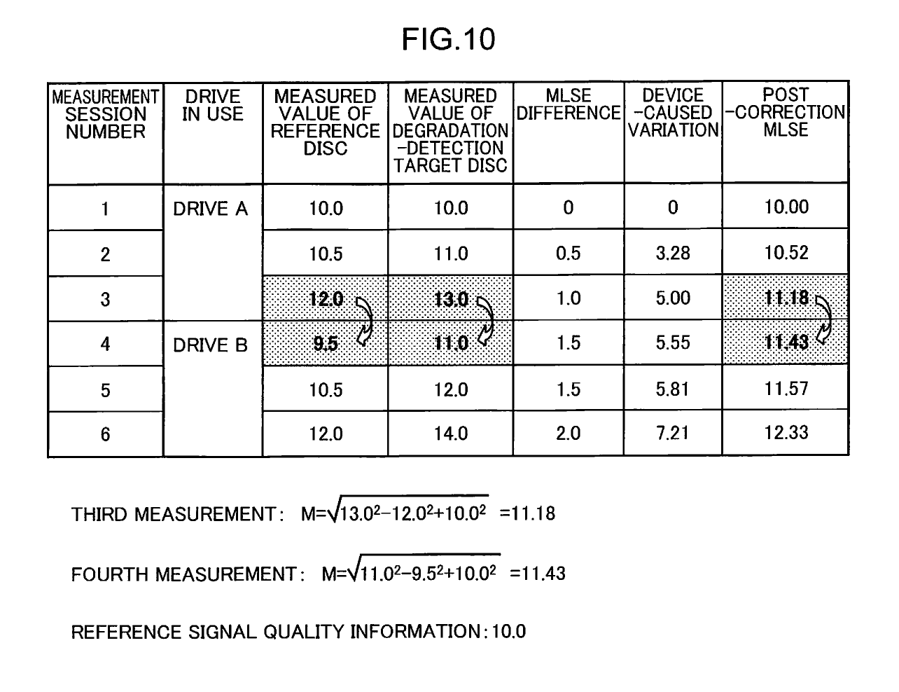

Next, using FIG. 10, a description will be given of a correction method in the present embodiment showing specific numerical values as examples. FIG. 10 is a view showing various measured values and post-correction MLSEs when the same degradation-detection target disc is subjected to degradation detection using two drive devices. In FIG. 10, the case is assumed where measurement is performed three times in the drive A, and then the drive A fails and is replaced with the drive B.

First, it is assumed that the reference signal quality information is 10.0%. Note that, since the same reference disc is used, the reference signal quality information is not changed even when the drive device is replaced. Accordingly, in the fourth and subsequent measurements also, as the reference signal quality information, 10.0% is used. Using the reference signal quality information Mi, the measured value of the reference disc (reference-disc measured signal quality information Ms), and the measured value of the degradation-detection target disc (degradation-detection-target-disc measured signal quality information Mm), the post-correction MLSEs (degradation-detection-target-disc corrected signal quality information M) are determined on the basis of Numerical Expression (5), which are as shown in FIG. 10.

Here, attention is focused on the measured values of the reference disc obtained by the third measurement prior to the drive replacement and by the fourth measurement after the drive replacement. Since the measured value of the reference disc has changed from 12.0% to 9.5%, it will be understood that drive performance has increased. Since the performance of the drive device has improved, the measured value obtained from the degradation-detection target disc in the fourth measurement has improved from the measured value obtained from the degradation-detection target disc in the third measurement.

Accordingly, in terms only of the measured values obtained from the degradation-detection target disc, it is determined that the degradation-detection target disc has not degraded. In addition, when lifetime prediction is performed using the improved measured values, the lifetime is predicted to be longer than the actual lifetime despite the degradation of the optical disc. As a result, a situation is encountered where, against the user's assumption that the optical disc has not come to the end of its life, information cannot actually be read and important information may be lost.

However, when the measured MLSEs are corrected on the basis of Numerical Expression (5), 11.18% is obtained in the third measurement and 11.43% is obtained in the fourth measurement. Therefore, it can be seen that the degradation-detection target disc has degraded. Thus, in the present embodiment, even in such a case where the performance of the drive device has changed as a result of performing drive replacement or the like, the degradation of the optical disc can be correctly detected.

Also in the present embodiment, by performing degradation detection or lifetime prediction using the corrected MLSEs, correct degradation detection or lifetime prediction can be performed. This can prevent a situation where important data is lost by determining that there is no degradation even though there is actually degradation or information is re-recorded to another optical disc by determining that there is degradation even though there is actually no degradation and such re-recording need not originally be performed, resulting in waste of the optical disc.

When the MLSE difference (difference between the measured value of the reference disc and the measured value of the degradation-detection target disc) is viewed, the MLSE difference in the third measurement is 1.0 and the MLSE difference in the fourth measurement is 1.5. This allows the degradation of the optical disc to be determined even though the performance of the drive device has improved as a result of the drive replacement. However, if attention is focused on the MLSE difference in the fourth measurement and the MLSE difference in the fifth measurement, the MLSE differences are the same. Therefore, it is impossible to precisely detect to what degree the optical disc has degraded.

However, in the present embodiment, the measured MLSEs are corrected on the basis of Numerical Expression (5). As a result, 11.43% is obtained in the fourth measurement and 11.57% is obtained in the fifth measurement and it is possible to precisely detect the degree of degradation of the degradation-detection target disc. Accordingly, in the case of measuring such signal quality information as MLSEs each represented by a standard deviation, the device-caused variation is determined using not the difference between measured values, but values obtained by squaring the measured values for linearizing the variation, and the correction of the signal quality information is performed. This allows more precise detection of the degradation of the optical disc.

Thus, in the present embodiment, the degradation of the optical disc can be detected even when drive replacement is performed. Therefore, the present embodiment is useful for a drive device to be mounted in an archive device which continues to use the same optical disc for a long period of time, while performing drive replacement.

Note that, in the present embodiment, the signal quality information measured using the standard evaluation tool is used as the reference signal quality information. However, it may also be possible to use the signal quality information measured when the drive device 101 of the information reproduction unit 100 is initially used as the reference signal quality information. This is because, since the drive device 101 has not degraded when initially used, the device-caused variation is 0 and, since the reference disc has not also degraded, the disc-caused variation is also 0.

In this case, when the drive device 101 of the information reproduction unit 100 is replaced with another drive device, the signal quality information of the reference disc measured when the replacing drive device is initially used is compared to the pre-replacement reference signal quality information. When the signal quality information measured in the replacing drive device is smaller than the pre-replacement reference signal quality information, the signal quality information measured in the replacing drive device is used as the reference signal quality information. On the other hand, when the signal quality information measured in the replacing drive device is not smaller than the pre-replacement reference signal quality information, the pre-replacement reference signal quality information is used as the reference signal quality information. That is, the smaller signal quality information is used as the reference signal quality information.

The signal quality information difference results from an individual difference due to variations in the drive device during the manufacturing thereof. By using the smaller signal quality information, it is possible to remove the variation in signal quality information resulting from the individual difference between the drive devices and therefore perform more precise correction.

When a comparison is made as described above, the pre-replacement reference signal quality information is necessary. However, since the signal-quality-information storage section 112 is in the drive device 101, if the drive device 101 is replaced, the pre-replacement reference signal quality information cannot be acquired. To prevent this, when the drive device 101 is replaced with another drive device, it may also be possible to use the signal-quality information of the reference disc measured when the replacing drive device is initially used as the reference signal quality information. This eliminates the need to hold the pre-replacement reference signal quality information and simplifies the configuration.

It has been assumed that, when the signal quality information measured using the standard evaluation tool is used as the reference signal quality information or the reference disc is replaced, the reference signal quality information is also updated. However, when the signal quality information measured when the drive device is initially used is used as the reference signal quality information, the reference signal quality information is not updated. This is because, if the reference disc is replaced while the drive device is being used, the device-caused variation is included in the reference signal quality information and therefore a precise device-caused variation cannot be detected.

It has also been assumed that the reference signal quality information is measured when the drive device is initially used, but it may also be possible to store the signal quality information measured at the time of its shipment from a factory in the signal-quality-information storage section 112. If the time elapsed from the initial use of the drive device 101 is short and the degradation of the drive device 101 within the elapsed time can be ignored, the signal quality information measured at that time may also be used as the reference signal quality information. It has also been assumed that a test disc is used as the reference disc, but a commercially available BD, which is easily obtainable, may also be used instead.

It has also been assumed in the present embodiment that the reference disc has not degraded or the degradation thereof can be ignored. Accordingly, to confirm that the reference disc has not degraded, the reference disc may also be measured at predetermined time intervals using the standard evaluation tool described above.

Note that each of the time intervals at which the measurement is performed using the standard evaluation tool is sufficient if the degradation of the reference disc within the time interval can be ignored, i.e., the time interval is sufficiently shorter than the assumed disc lifetime. For example, it is sufficient if the time interval is shorter than 1/10 of the assumed disc lifetime.

At this time, when the degradation of the reference disc can no longer be ignored, it may also be possible to replace the reference disc with a new reference disc and store the signal quality information obtained by performing a measurement on the new reference disc using the standard evaluation tool as the reference signal quality information in the signal-quality-information storage section 112. Thus, the device-caused variation is determined using the reference signal quality information corresponding to the new reference disc, and therefore the device-caused variation can be detected more precisely.

It may also be possible to replace the reference disc with an optical disc having performance equivalent to the reference signal quality information. In this case, since the performance is equivalent thereto, the reference signal quality information need not be updated. This allows easier replacement of the reference disc.

It has also been assumed that, in the present embodiment, the reference signal quality information is stored in the signal-quality-information storage section 112. However, it may also be possible to store the reference signal quality information in a higher-order control device and acquire the reference signal quality information from the higher-order control device when the device-caused variation is detected. Alternatively, it may also be possible that the drive device 101 has a network function and the reference signal quality information is stored in another control device such as a server connected thereto via a network to be acquired via the network.

It has also been assumed that, in the correction method in the present embodiment, the correction is performed in Step S205 by removing the device-caused variation from the degradation-detection-target-disc measured quality information of the degradation-detection target disc. When the disc-caused variation is assumed to be Vm, the disc-caused variation Vm can be determined from the degradation-detection-target-disc measured signal quality information Mm and the reference-disc measured signal quality information Ms. Accordingly, when Numerical Expression (5) is transformed, Numerical Expression (6) shown below is obtained and, as long as the reference signal quality information Mi and the disc-caused variation Vm can be detected, the signal quality information can be corrected. Consequently, the correction may also be performed by detecting, not the device-caused variation, but the disc-caused variation.

$$\begin{matrix}[ Numerical Expression 6 ] & \\ \begin{matrix}M = \sqrt{{Mm}^{2} - {Ms}^{2} + {Mi}^{2}} \\ = \sqrt{{Mi}^{2} + ( {Mm}^{2} - {Ms}^{2} )} \\ = \sqrt{{Mi}^{2} + {Vm}^{2}}\end{matrix} & ( 6 )\end{matrix}$$

In the present embodiment, the description has been given on the assumption that the signal quality information is the MLSEs. However, it is sufficient if the signal quality information is an index with which the performance of the optical disc can be evaluated. The signal quality information may also be a modulation degree, beta, jitter, C/N, S/N, bit error rate, symbol error rate, i-MLSE, or the like. Here, the jitter is a variation in reproduced signal on a time axis with respect to clock signal and represented by a standard deviation. Similarly to the MLSE, a post-correction jitter is determined using Numerical Expression (5). In the bit error or symbol error, as shown in Numerical Expression (7), a variation is linear. Accordingly, the correction can be performed not by determining the difference between the values obtained by squaring the measured values, but by directly determining the difference between the measured values.

$$\begin{matrix}[ Numerical Expression 7 ] & \\ ( Error Rate ) = \frac{( Number of Faulty Data Items )}{( Total Number of Data Items )} & ( 7 )\end{matrix}$$

The measurement of the signal quality information of the degradation-detection target disc in Step S204 may also be performed in advance when user data is reproduced. This eliminates the need to perform the measurement only to detect the degradation of the degradation-detection target disc and can reduce the load placed by the correction process on the process of recording/reproducing the user data.

The measurement of the signal quality information of the degradation-detection target disc in Step S204 need not be performed immediately after the signal quality information of the reference disc is measured. It is sufficient if the interval between the measurements performed on the two discs is within a time within which the degradation of the drive device 101 can be ignored.

It may also be possible that the drive control section 107 in the present embodiment further includes a recording section which records data on the optical disc to provide the information reproduction device as an information recording/reproduction device. In this case, it may also be possible to produce a recording region for measuring signal quality information using the recording section and measure the signal quality information in the produced region. As a result, the signal quality information can be measured in the region where the same data is recorded to allow more precise signal quality information to be obtained.

Thus, according to the present embodiment, by detecting the device-caused variation using the reference disc and correcting the measured signal quality information to the signal quality information from which the device-caused variation has been removed, the degradation of the information recording medium can be detected correctly. In addition, even when the performance of the drive device is changed by the replacement of the drive device 101 or the like, the degradation of the optical disc 114 can be detected correctly. By also performing degradation detection or lifetime prediction using the corrected signal quality information, correct degradation detection or lifetime prediction can be performed. This can prevent a situation where important data is lost by determining that there is no degradation even though there is actually degradation or information is re-recorded to another optical disc by determining that there is degradation even though there is actually no degradation and such re-recording need not originally be performed, resulting in waste of the optical disc.

### Embodiment 2

In Embodiment 1 described above, every time the degradation of the degradation-detection target disc is detected, using the signal-quality-information measurement section 109, the reference-disc measured signal quality information as the signal quality information of the reference disc is measured. As a result, if the degradation-detection-target-disc measured signal quality information of the degradation-detection target disc is to be corrected, the reference disc and the degradation-detection target disc need to be attached to the drive device 101 and, consequently, disc replacement needs to be performed.

In this case, even when the drive device 101 is provided with a changer function for automatically changing discs to allow automatic replacement of the reference disc and the degradation-detection target disc, the disc replacement takes time. Even when the disc replacement is performed manually, the disc replacement takes more time.

In addition, a measurement on the reference disc also takes time to place a further load on the process performed in the drive control section 107. That is, since the drive control section 107 performs the process of recording/reproducing user data to/from the optical disc 114, a load is placed on the process performed in the drive control section 107. This also affects the process of recording/reproducing user data inherent to the drive control section 107 to degrade an access speed and the convenience of the user.

When the signal quality information of the degradation-detection target disc is corrected, the measurement is performed on the reference disc so as to detect the device-caused variation as the variation in the signal quality information that has degraded due to the drive device 101. That is, as long as the device-caused variation can be precisely detected, there is no need to perform a measurement on the reference disc every time the correction is performed.

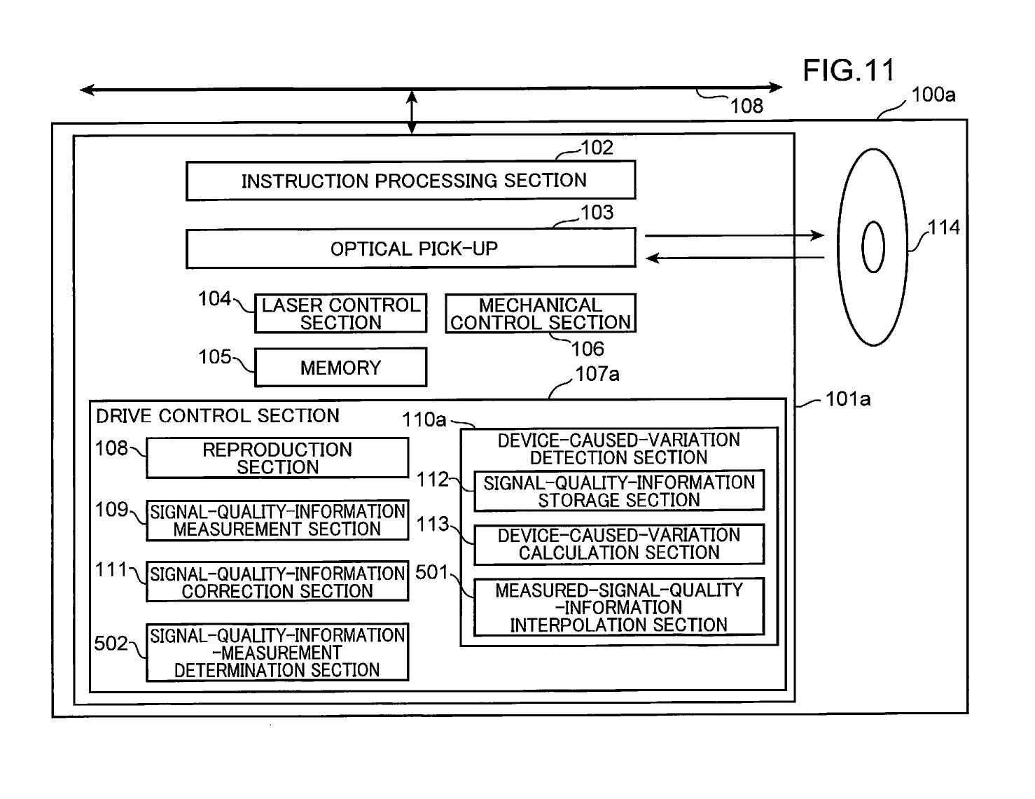

Accordingly, in Embodiment 2 of the present invention, a description will be given of an information reproduction unit which reduces the processing time required for correcting the signal quality information and the load resulting therefrom and a correction method for the signal quality information. FIG. 11 is a view showing a configuration of the information reproduction unit in Embodiment 2 of the present invention. Note that, in FIG. 11, the same components as shown in FIG. 1 are designated by the same reference numerals and a repeated detailed description thereof is omitted. Also in Embodiment 2, in the same manner as in Embodiment 1, it is assumed that the disc to be subjected to degradation detection is the degradation-detection target disc and the disc having known reference signal quality information is the reference disc.

An information reproduction unit 100a shown in FIG. 11 includes a drive device 101a, and the optical disc 114. The drive device 101a includes a drive control section 107a in place of the drive control section 107 shown in FIG. 1. The drive control section 107a includes a device-caused-variation detection section 110a in place of the device-caused-variation detection section 110 shown in FIG. 1. The device-caused-variation detection section 110a further includes a measured-signal-quality-information interpolation section 501 in addition to the signal-quality-information storage section 112 and the device-caused-variation calculation section 113.

When measuring the reference-disc measured signal quality information which is the signal quality information of the reference disc using the signal-quality-information measurement section 109, the device-caused-variation detection section 110a stores the measured reference-disc measured signal quality information in the signal-quality-information storage section 112.

In the case where the measured-signal-quality-information interpolation section 501 does not measure the reference-disc measured signal quality information using the signal-quality-information measurement section 109 when correcting the measured signal quality information, the measured-signal-quality-information interpolation section 501 calculates reference-disc estimated signal quality information (an example of reference-medium estimated signal quality information) using the reference-disc measured signal quality information previously measured and stored in the signal-quality-information storage section 112. The device-caused-variation detection section 110a detects the device-caused variation as the variation in the signal quality information that has degraded due to the drive device 101a using the reference-disc estimated signal quality information calculated by the measured-signal-quality-information interpolation section 501 and the reference signal quality information stored in the signal-quality-information storage section 112.

The drive control section 107a further includes a signal-quality-information-measurement determination section 502 in addition to the reproduction section 108, the signal-quality-information measurement section 109, the device-caused-variation detection section 110a, and the signal-quality-information correction section 111. The signal-quality-information-measurement determination section 502 determines whether or not a measurement is to be performed on the reference disc. In the present embodiment also, in the same manner as in Embodiment 1, it is assumed that the reference signal quality information is stored in the signal-quality-information storage section 112.

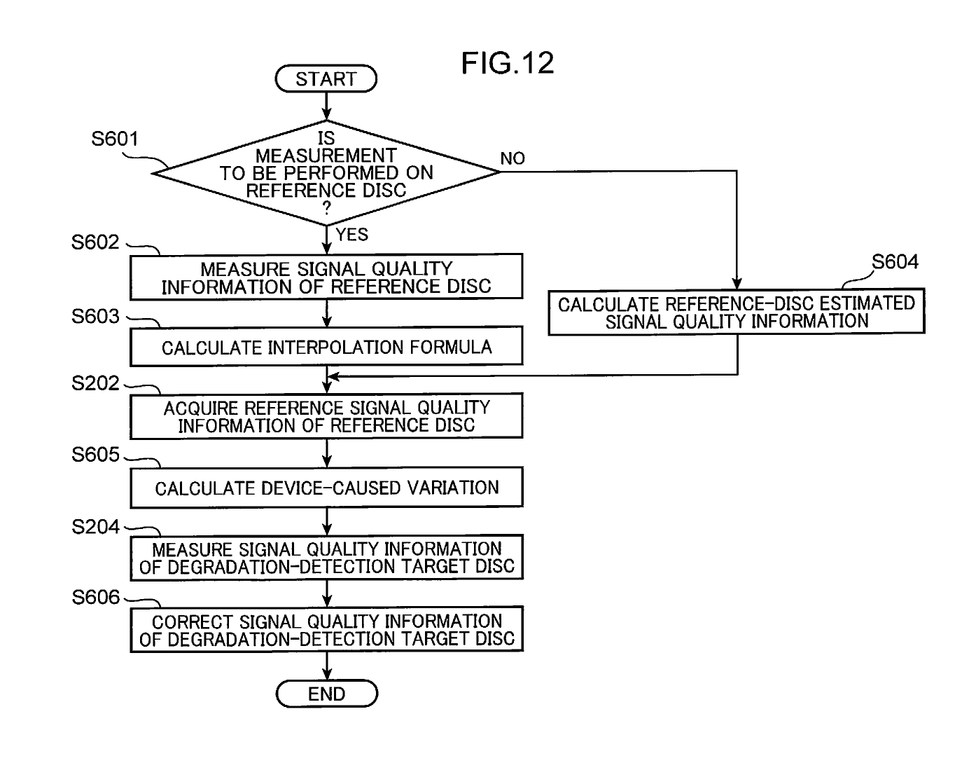

Next, using FIG. 12, a correction method for signal quality information in the information reproduction unit in the present embodiment will be described. FIG. 12 is a flow chart showing the correction method for signal quality information in the information reproduction unit in Embodiment 2 of the present invention. Note that, in FIG. 12, the same processes as in the flow chart of FIG. 6 are designated by the same reference numerals and a repeated detailed description thereof is omitted.

First, in Step S601, the signal-quality-information-measurement determination section 502 determines whether or not a measurement is to be performed on the reference disc. For example, using the internal clock portion thereof, the signal-quality-information-measurement determination section 502 determines whether or not a predetermined time has elapsed since the previous measurement performed on the reference disc. When the predetermined time has elapsed, the signal-quality-information-measurement determination section 502 determines that a measurement is to be performed on the reference disc and the flow advances to Step S602. When the predetermined time has not elapsed, the signal-quality-information-measurement determination section 502 determines that no measurement is to be performed on the reference disc and the flow advances to Step S604.

When it is determined in Step S601 that a measurement is to be performed on the reference disc, in Step S602, the device-caused-variation detection section 110a measures the signal quality information of the reference disc using the signal-quality-information measurement section 109. Specifically, when the reference disc is attached to the drive device 101a, the device-caused-variation detection section 110a measures the signal quality information of the reference disc using the signal-quality-information measurement section 109. The signal-quality-information measurement section 109 controls the optical pick-up 103, the laser control section 104, and the mechanical control section 106 to irradiate the reference disc with a laser beam and obtain a reproduced signal. The device-caused-variation detection section 110a measures the signal quality information from the obtained reproduced signal. It is assumed here that the signal quality information obtained by measuring the reference disc is the reference-disc measured signal quality information Ms.

To calculate an interpolation formula, the device-caused-variation detection section 110a also stores the measured reference-disc measured signal quality information and a measurement time point in the signal-quality-information storage section 112.

Next, in Step S603, the measured-signal-quality-information interpolation section 501 calculates the interpolation formula. Specifically, when the signal quality information of the reference disc is measured, the measured-signal-quality-information interpolation section 501 calculates the interpolation formula used to calculate the reference-disc estimated signal quality information Me using the measured signal quality information and the measurement time point as well as the previously measured reference-disc measured signal quality information and the previous measurement time point each stored in the signal-quality-information storage section 112.

On the other hand, when it is determined in Step S601 that no measurement is to be performed on the reference disc, in Step S604, the measured-signal-quality-information interpolation section 501 calculates the reference-disc estimated signal quality information Me. Specifically, when it is determined in Step S601 that no measurement is to be performed on the reference disc, the reference-disc measured signal quality information cannot be obtained so that the measured-signal-quality-information interpolation section 501 calculates the reference-disc estimated signal quality information Me using the interpolation formula obtained in Step S603. A specific calculation method will be described later.

Next, after the process in Step S202 is ended, in Step S605, the device-caused-variation calculation section 113 calculates the device-caused variation. Specifically, when it is determined in Step S601 that a measurement is to be performed on the reference disc, in Step S605, the device-caused-variation calculation section 113 calculates the device-caused variation Vc from the reference-disc measured signal quality information Ms obtained in Step S602 and the reference signal quality information Mi of the reference disc acquired in Step S202.

On the other hand, when it is determined in Step S601 that no measurement is to be performed on the reference disc, in Step S605, the device-caused-variation calculation section 113 calculates the device-caused variation Vc from the reference-disc estimated signal quality information Me calculated in Step S604 and the reference signal quality information Mi of the reference disc acquired in Step S202. That is, when it is determined in Step S601 that no measurement is to be performed on the reference disc, the device-caused-variation calculation section 113 calculates the device-caused variation Vc using the reference-disc estimated signal quality information Me instead of the reference-disc measured signal quality information Ms.

Next, after the process in Step S204 is ended, in Step S606, the signal-quality-information correction section 111 corrects the signal quality information of the degradation-detection target disc. Specifically, the signal-quality-information correction section 111 removes the device-caused variation Vc obtained in Step S605 from the degradation-detection-target-disc measured signal quality information Mm obtained in Step S204 to correct the degradation-detection-target-disc measured signal quality information Mm. It is assumed here that the corrected degradation-detection-target-disc measured signal quality information is degradation-detection-target-disc corrected signal quality information M.

Thus, in accordance with the correction method in the present embodiment, between the previous measurement of the signal quality information of the reference disc and the most recent measurement of the signal quality information of the reference disc, the signal quality information of the degradation-detection target disc is measured a plurality of times and, to correct the signal quality information of the degradation-detection target disc measured between the previous measurement of the signal quality information of the reference disc and the most recent measurement of the signal quality information of the reference disc, the reference-disc estimated signal quality information is used.

It has been assumed that, in Step S601, whether or not a measurement is to be performed on the reference disc is determined on the basis of whether or not the predetermined time has elapsed from the immediately previous measurement on the reference disc, but the determination is not limited thereto. It may also be possible to, e.g., determine whether or not the number of times a measurement has been performed on the degradation-detection target disc after the immediately previous measurement was performed on the reference disc is not less than a predetermined number of times and then determine that a measurement is to be performed on the reference disc when the number of times a measurement has been performed on the degradation-detection target disc is not less than the predetermined number of times.

Alternatively, it may also be possible to determine whether or not the optical disc attached to the drive device 101a is the reference disc and determine that a measurement is to be performed on the reference disc when the optical disc attached to the drive device 101a is the reference disc. It may also be possible to determine whether or not the difference between the degradation-detection-target-disc measured signal quality information, which is a value obtained by performing a measurement on the degradation-detection target disc, and the immediately previously measured reference-disc measured signal quality information is not less than a predetermine value and determine that a measurement is to be performed on the reference disc when the difference therebetween is not less than the predetermine value.

Otherwise, it may also be possible to determine, to linearize the variation in signal quality information, whether or not the difference between a value obtained by squaring the degradation-detection-target-disc measured signal quality information and a value obtained by squaring the immediately previously measured reference-disc measured signal quality information is not less than a predetermined value and determine that a measurement is to be performed on the reference disc when the difference therebetween is not less than the predetermined value. That is, it may also be possible to determine whether or not the variation between the degradation-detection-target-disc measured signal quality information and the immediately previously measured reference-disc measured signal quality information is not less than a predetermined value and determine that a measurement is to be performed on the reference disc when the variation therebetween is not less than the predetermined value. It may also be possible to determine whether or not the degradation-detection-target-disc measured signal quality information is not less than a predetermined value and determine that a measurement is to be performed on the reference disc when the degradation-detection-target-disc measured signal quality information is not less than the predetermined value.

It is sufficient if each of the time intervals at which the reference disc is measured is shorter than the assumed disc lifetime of the optical disc and the assumed drive lifetime of the drive device and have a length which does not affect the process of recording/reproducing user data. For example, the time interval may be about several hours or several days such as one day or three days so that a measurement is performed every day or every three days. The time interval may also be several months such as one month or six months so that a measurement is performed every month or every six months. The time interval may also be about several years so that a measurement is performed at the time of annual maintenance.

The reference disc may also be attached to the drive device 101a at the time of maintenance or the like and subjected to a measurement.

It has been assumed that, after the signal quality information of the reference disc is measured in Step S602, the interpolation formula is calculated in Step S603. However, the time when the interpolation formula is calculated is not limited thereto and it is sufficient if the interpolation formula is calculated before the reference-disc estimated signal quality information is calculated. For example, the calculation of the interpolation formula may also be performed after the signal quality information of the degradation-detection target disc is corrected in Step S606. This allows early correction of the signal quality information of the degradation-detection target disc measured in Step S204.

The calculation of the interpolation formula may also be performed when the drive device 101a is not performing recording or reproduction. This allows the interpolation formula to be calculated without affecting the recording/reproduction process in the drive device 101a and without degrading the convenience of the user.

Next, a description will be given of a method of calculating the interpolation formula in Step S603 and a method of calculating the reference-disc estimated signal quality information Me in Step S604.

First, as a first method of calculating the interpolation formula, there is a method which obtains an approximation formula representing a variation with elapsed time in reference-disc measured signal quality information using the previously measured reference-disc measured signal quality information, uses the approximation formula as the interpolation formula, and provides the value of the interpolation formula at the time when a measurement is performed on the degradation-detection target disc as the reference-disc estimated signal quality information.

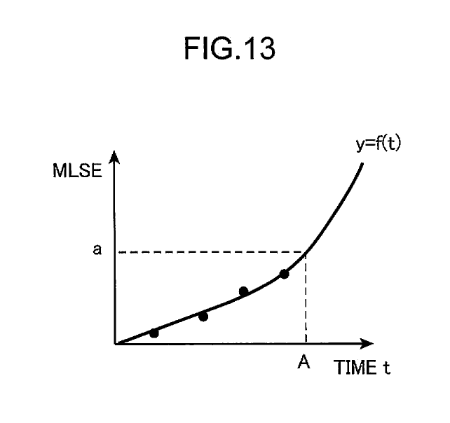

FIG. 13 is a view showing a change in reference-disc estimated signal quality information when the first method of calculating the interpolation formula is used. An interpolation formula f(t) is obtained from the previously measured reference-disc measured quality information (measured values shown by the solid circles in the drawing) and provides a value a at a time A when a measurement is performed on the degradation-detection target disc as the reference-disc estimated signal quality information. Here, for the approximation formula, various functions such as a linear function, a quadratic function, and an exponent function can be used. By thus obtaining the approximation formula using the previously measured reference-disc measured signal quality information and using the approximation formula as the interpolation formula, more precise reference-disc estimated signal quality information can be obtained.

Note that the method of obtaining the approximation formula is not limited thereto. The approximation formula may be obtained appropriately within a range which does not affect the process of recording/reproducing data. For example, the approximation formula may also be a formula obtained by performing linear approximation using two points in the previously measured reference-disc measured signal quality information and in the most recently measured reference-disc measured signal quality information. This allows the reference-disc estimated signal quality information based on actually measured values to be obtained without obtaining a complicated approximation formula.

The approximation formula may also be obtained using all the previously measured reference-disc measured signal quality information items stored in the signal-quality-information storage section 112. This allows precise reference-disc estimated signal quality information having small measurement-to-measurement variation to be obtained. Note that, when approximation is performed using all the previously measured reference-disc measured signal quality information items, the amount of data is increased. Accordingly, it may also be possible to perform approximation using a predetermined number of reference-disc measured signal quality information items which does not complicate the approximation, while suppressing variations, e.g., five reference-disc measured signal quality information items. This can reduce the process required for the approximation. Note that the method of obtaining the approximation formula is not limited thereto. The approximation formula may be determined appropriately within a range which does not affect the process of recording or reproducing data.

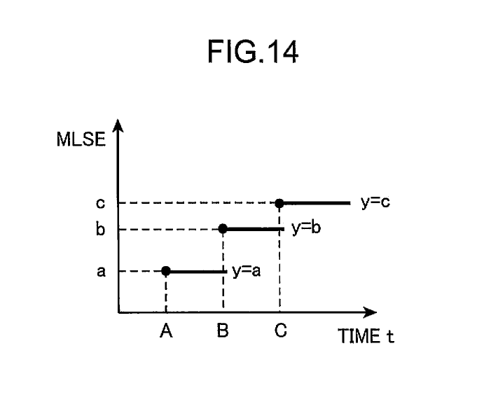

Next, as a second method of calculating the interpolation formula, there is a method which provides the immediately previously measured reference-disc measured signal quality information as the reference-disc estimated signal quality information. FIG. 14 is a view showing a change in reference-disc estimated signal quality information when the second method of calculating the interpolation formula is used.

As shown in FIG. 14, during the A-B period after the first measurement is completed and before the second measurement is performed, the reference-disc measured signal quality information a, which is the value obtained by the first measurement, is used as the reference-disc estimated signal quality information. That is, the interpolation formula f (t) is given by f(t)=a. Likewise, during the B-C period, the reference-disc measured signal quality information b, which is the value obtained by the second measurement, is used. That is, the interpolation formula f(t) is given by f(t)=b. Hereinbelow, the reference-disc measured signal quality information items each measured immediately previously are similarly used in succession each as the reference-disc estimated signal quality information.

When the reference-disc measured signal quality information that has been measured immediately previously is thus used, the reference-disc estimated signal quality information can be obtained without a complicated process such as that of obtaining an approximation formula. In addition, it is sufficient to store only the reference-disc measured signal quality information that has been measured immediately previously in the signal-quality-information storage section 112. This can reduce the scale of the configuration of the signal-quality-information storage section 112.

In addition, as a result of using the reference-disc measured signal quality information that has been measured immediately previously, the total variation in the signal quality information that has degraded after the immediately previous measurement was performed on the reference disc and before the signal quality information of the degradation-detection target disc is measured serves as the disc-caused variation. As a result, in terms of data loss, it is possible to provide a safety-oriented mechanism by which data is less likely to be lost.

This is because the data is recorded on the optical disc and, even when the drive device 101a fails, as long as the data can be read from the optical disc, the data can be reproduced using another drive device so that there is no data loss. That is, in terms of data loss, by assuming that the entire degradation that has occurred after the immediately previous measurement was performed on the reference disc is due to the disc, there is no data loss resulting from the determination that there is no degradation even though there is actually degradation. Therefore, it is possible to provide the safe-oriented mechanism by which data is less likely to be lost.

In addition, it is only during the period during which no measurement is performed on the reference disc that the total variation in signal quality information is assumed to be the disc-caused variation. When a measurement is performed on the reference disc, the reference-disc measured signal quality information is updated to the reference-disc measured signal quality information including a correct device-caused variation. Accordingly, compared to the case where the degradation of the optical disc is determined without using the reference disc, the degradation of the optical disc can be determined more precisely.

Next, as a third method of calculating the interpolation formula, there is a method which performs an acceleration test or the like using the reference disc and the drive device, preliminarily calculates and stores an approximation formula for a change with time in the MLSE of the reference disc, and uses the approximation formula as the interpolation formula to provide the value of the interpolation formula at the time when a measurement is performed on the degradation-detection target disc as the reference-disc estimated signal quality information.

In accordance with such a third method of calculating the interpolation formula, it is unnecessary to obtain an approximation formula during the interpolation process to allow a reduction in interpolation process. In addition, since the preliminarily obtained approximation formula is an approximation formula obtained by an actual test such as an acceleration test, the approximation formula represents an actual change with time. Therefore, it is possible to obtain more precise reference-disc estimated signal quality information.

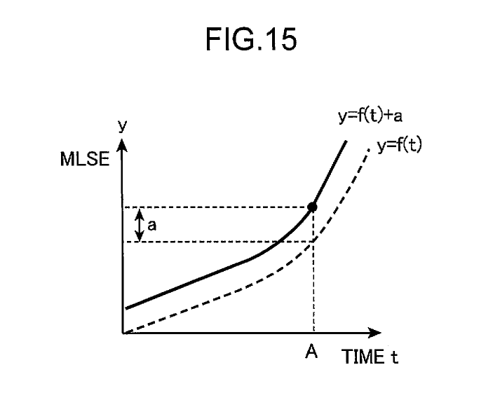

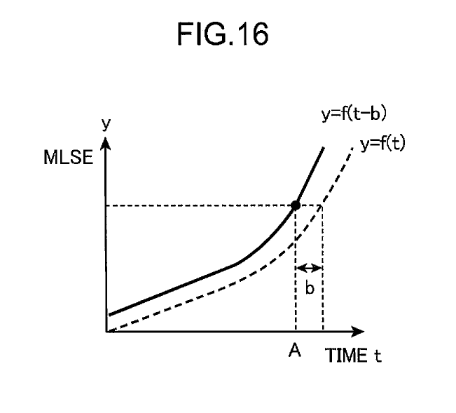

Alternatively, as shown in FIGS. 15 and 16, when a measurement is performed on the reference disc, it may also be possible to move the preliminarily obtained approximation formula mentioned above in parallel with the y-axis or t-axis using the measured signal quality information and use an approximation formula resulting from the parallel measurement as the interpolation formula.

FIG. 15 is a view obtained by moving the preliminarily obtained approximation formula in parallel with the y-axis. Since the preliminarily obtained approximation formula y=f(t) represents an actual change with time, when the interpolation formula y=f(t)+a resulting from the parallel movement of the preliminarily obtained approximation formula with the y-axis direction is used, it is possible to obtain more precise reference-disc estimated signal quality information relative to the time change.

FIG. 16 is a view obtained by moving the preliminarily obtained approximation formula in parallel with the t-axis. When the interpolation formula y=f(t−b) obtained by moving the approximation formula y=f(t) in parallel with the t-axis direction is used, it is possible to obtain more precise reference-disc estimated signal quality information relative to a change in the amount of degradation.

Note that the direction of the parallel movement is either one of the directions and may also be constantly the same. This allows the interpolation formula to be easily obtained. The direction of the parallel movement need not constantly be the same and may also be changed in accordance with the measured signal quality information. For example, the approximation formula may be moved in parallel with the direction in which the difference with the previous signal quality information decreases. This reduces the error with the previous signal quality information and thus allows more precise reference-disc estimated signal quality information to be obtained.

When the drive device 101a is replaced with another drive device as a result of the failure or degradation thereof, the reference disc is newly measured using the replacing drive device and, using only the reference-disc measured signal quality information measured using the replacing drive device, the interpolation formula is calculated. Accordingly, when the drive device is replaced, there is no need to move the reference-disc signal quality information stored in the signal-quality-information storage section 112 of the drive device 101a to the replacing drive device. As a result, even when the drive device is replaced, it is possible to continuously perform easy correction of the signal quality information without any trouble.

As described above, when the correction method in the information reproduction unit in the present embodiment is used, it is possible to precisely correct the signal quality information by obtaining the reference-disc estimated signal quality information using the previously measured reference-disc measured signal quality information, obtaining the device-caused variation using the reference-disc estimated signal quality information and the reference signal quality information, and thereby reducing the number of times a measurement is performed on the reference disc, while reducing the processing time required for the correction of the signal quality information and the load resulting therefrom.

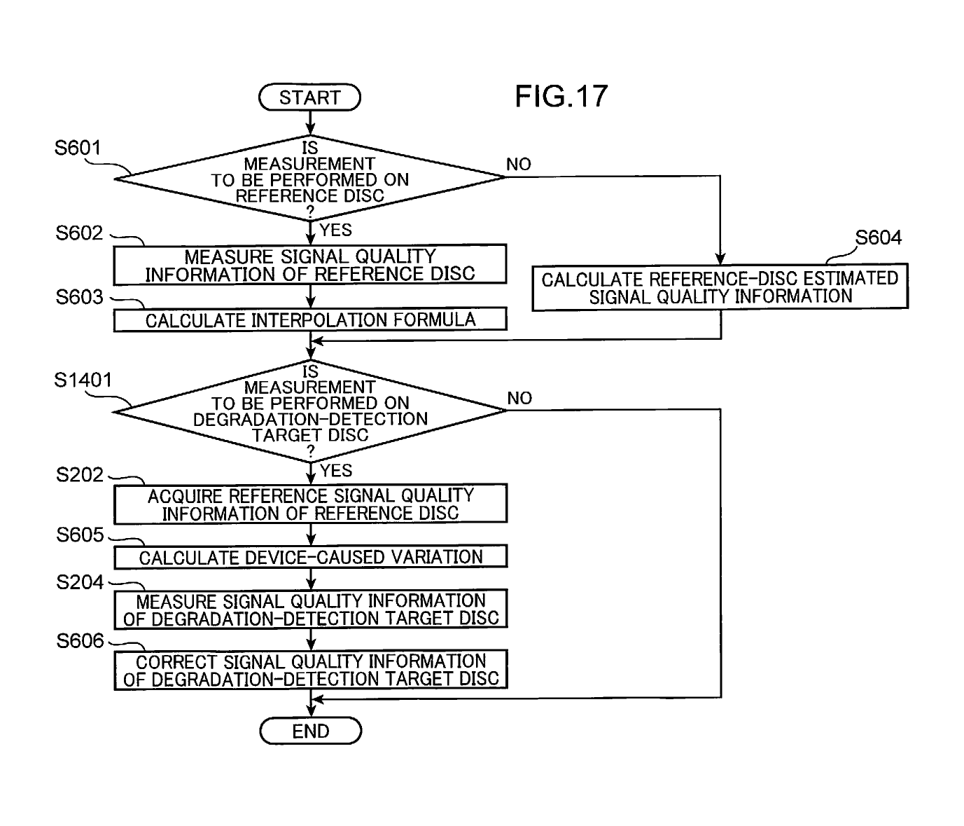

In the present embodiment, it has been assumed that a measurement is performed on the degradation-detection target disc every time the disc is attached to the drive device 101a. However, it is sufficient if the degree of degradation thereof can be determined and the measurement need not be performed thereon every time the degradation-detection target disc is attached to the drive device 101a. Accordingly, using FIG. 17, a description will be given of a correction method when the number of times a measurement is performed on the degradation-detection target disc is reduced.

FIG. 17 is a flow chart showing the correction method when the number of times a measurement is performed on the degradation-detection target disc is reduced in the information reproduction unit in the present embodiment. Note that, in FIG. 17, the same processes as in the flow charts of FIGS. 6 and 12 are designated by the same reference numerals and a repeated detailed description thereof is omitted.

First, the processes in Steps S601 to S604 are performed. Then, in Step S1401, the signal-quality-information-measurement determination section 502 determines whether or not a measurement is to be performed on the degradation-detection target disc. For example, using the internal clock portion thereof, the signal-quality-information-measurement determination section 502 determines whether or not a predetermined time has elapsed since the immediately previous measurement was performed on the degradation-detection target disc. When the predetermined time has elapsed, the signal-quality-information-measurement determination section 502 determines that a measurement is to be performed on the degradation-detection target disc, advances to Step S202, and performs the subsequent processes. When the predetermined time has not elapsed, the signal-quality-information-measurement determination section 502 determines that no measurement is to be performed on the degradation-determination target disc and ends the processes.

It has been assumed that, in Step S1401, whether or not a measurement is to be performed on the degradation-detection target disc is determined on the basis of whether or not the predetermined time has elapsed since the immediately previous measurement was performed on the degradation-detection target disc, but the determination is not limited thereto. For example, it may also be possible to determine whether or not the number of times the degradation-detection target disc has been attached after the immediately previous measurement was performed on the degradation-detection target disc is not less than a predetermine number of times and determine that a measurement is performed on the degradation-detection target disc when the number of times the degradation-detection target disc has been attached is not less than the predetermined number of times.

It may also be possible to determine whether or not a measurement has been performed on the reference disc and determine that a measurement is to be performed on the degradation-detection target disc when a measurement has been performed on the reference disc. Alternatively, it may also be possible to determine whether or not the number of times data has been recorded on the degradation-detection target disc is not less than a predetermined number of times and determine that a measurement is to be performed on the degradation-detection target disc when the number of times data has been recorded on the degradation-detection target disc is not less than the predetermined number of times. Likewise, the determination may also be performed on the basis of whether or not the number of times reproduction has been performed from the degradation-detection target disc, the number of times recording has been performed on the degradation-detection target disc, or the number of times the degradation-detection target disc has been attached to the drive device 101a is not less than a predetermined number of times. Otherwise, it may also be possible to determine whether or not a request to record/reproduce user data has been given to the instruction processing section 102 and determine that a measurement is to be performed on the degradation-detection target disc when there is no recording/reproduction request. As a result, when there is a request to record/reproduce user data, a measurement is not performed on the degradation-detection target disc to allow a reduction in the influence given to the recording/reproduction process in the information reproduction unit 100a.

It is sufficient if each of the time intervals at which a measurement is performed on the degradation-detection target disc is not more than each of the time intervals at which a measurement is performed on the reference disc. This allows a reduction in the number of times a measurement is performed on the degradation-detection target disc to allow a reduction in the influence given to the recording/reproduction process in the information reproduction unit 100a. This prevents the access speed from decreasing and impairing the convenience of the user.

### Embodiment 3

In Embodiment 2 described above, the reference-disc estimated signal quality information is calculated using the interpolation formula. This may cause a difference between the reference-disc estimated signal quality information at the time when a measurement is performed on the reference disc and the actually measured reference-disc measured signal quality information. The difference causes no problem as long as it is of the order which does not affect the device-caused variation when the device-caused variation is detected. However, the difference which affects the detection of the device-caused variation may be produced. When the device-caused variation cannot precisely be detected, the signal quality information of the degradation-detection target disc cannot precisely be corrected.

Accordingly, in Embodiment 3 of the present invention, a description will be given of an information reproduction unit which can precisely correct the signal quality information of the degradation-detection target disc even when the difference which may affect the device-caused variation when the device-caused variation is detected is produced between the reference-disc estimated signal quality information and the actually measured reference-disc measured signal quality information as well as a correction method for the signal quality information. Note that the configuration of the information reproduction unit in the present embodiment is the same as the configuration of the information reproduction unit shown in FIG. 11. Accordingly, a repeated detailed description thereof is omitted and the description will be given using each of the components shown in FIG. 11.

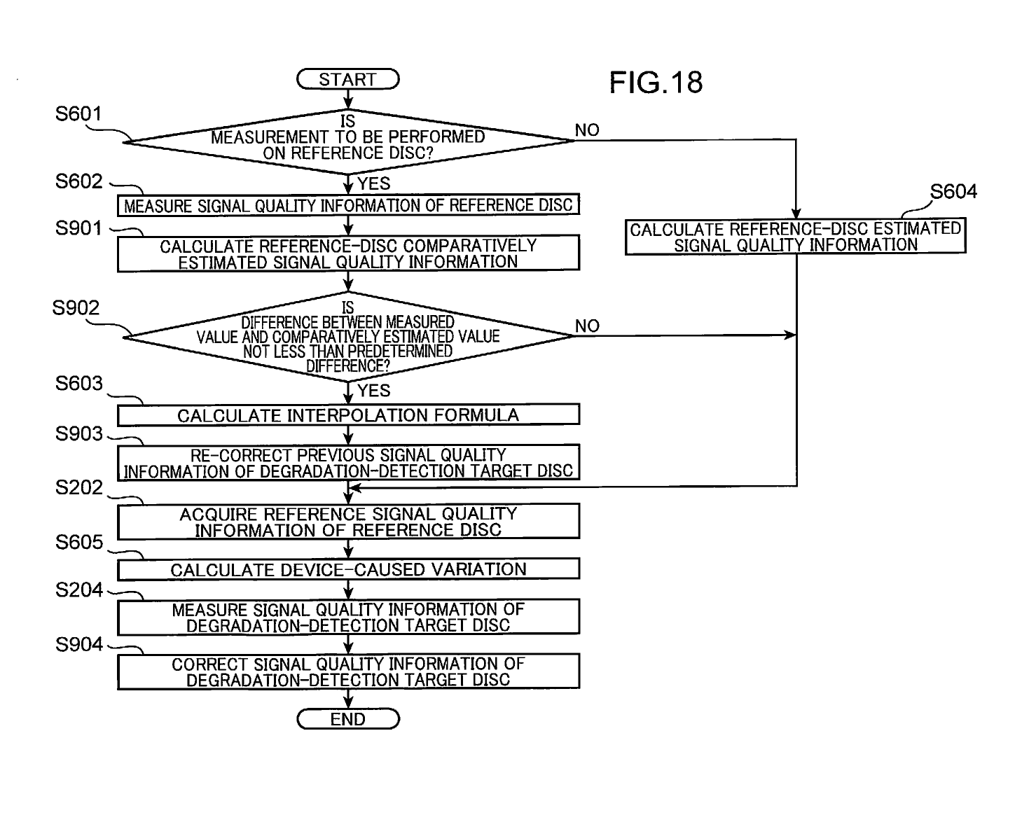

FIG. 18 is a flow chart showing the correction method in which the signal quality information of the degradation-detection target disc is corrected in the information reproduction unit in Embodiment 3 of the present invention. Note that, in FIG. 18, the same processes as in the flow charts of FIGS. 6 and 12 are designated by the same reference numerals and a detailed repeated description thereof is omitted.

First, the processes in Steps S601 and S602 are performed. Then, in Step S901, the measured-signal-quality-information interpolation section 501 calculates reference-disc comparatively estimated signal quality information (an example of comparatively estimated reference signal quality information). Specifically, using the interpolation formula calculated in Step S603 when the immediately previous measurement was performed, the measured-signal-quality-information interpolation section 501 calculates the value of the interpolation formula at the time when the reference-disc measured signal quality information as the signal quality information of the reference disc is measured in Step S602 using the signal-quality-information measurement section 109 and provides the calculated value as the reference-disc comparatively estimated signal quality information. Note that, when there is no interpolation formula, i.e., when a measurement is performed first on the reference disc, the reference-disc measured signal quality information measured in Step S602 is provided as the reference-disc comparatively estimated signal quality information.

Next, in Step S902, the measured-signal-quality-information interpolation section 501 determines whether or not the difference between the measured value and the comparatively estimated value is not less than a predetermined difference. Specifically, the measured-signal-quality-information interpolation section 501 determines whether or not the difference between the reference-disc measured signal quality information measured in Step S602 and the reference-disc comparatively estimated signal quality information calculated in Step S901 is not less than the predetermined value.

Here, when the difference between the reference-disc measured signal quality information and the reference-disc comparatively estimated signal quality information is not less than the predetermined value, an error in the interpolation formula is large and the device-caused variation cannot be precisely detected. Accordingly, when the difference between the reference-disc measured signal quality information and the reference-disc comparatively estimated signal quality information is not less than the predetermined value, the measured-signal-quality-information interpolation section 501 advances to Step S603 and re-calculates the interpolation formula using the reference-disc measured signal quality information that has been measured most recently in Step S602 and updates the interpolation formula used to calculate the reference-disc estimated signal quality information in Step S604 to an interpolation formula with a smaller error.

Next, in Step S903, the signal-quality-information correction section 111 re-corrects the previous signal quality information of the degradation-detection target disc. Specifically, since the error in the interpolation formula is large, the signal-quality-information correction section 111 re-corrects the previously corrected signal quality information of the degradation-detection target disc using the interpolation formula re-calculated in Step S603. A specific re-correction method will be described later.

On the other hand, when the difference between the reference-disc measured signal quality information and the reference-disc comparatively estimated signal quality information is not less than the predetermined value, the error in the interpolation formula is small and the interpolation formula can be used without being modified. Accordingly, the measured-signal-quality-information interpolation section 501 advances to Step S202 without calculating the interpolation formula.

Next, the processes in Steps S202, S605, and S204 are performed. Then, in Step S904, the signal-quality-information correction section 111 corrects the signal quality information of the degradation-detection target disc. Specifically, the signal-quality-information correction section 111 removes the device-caused variation Vc obtained in Step S605 from the degradation-detection-target-disc measured signal quality information Mm obtained in Step S204 to correct the degradation-detection-target-disc measured signal quality information Mm. It is assumed here that the corrected degradation-detection-target-disc measured signal quality information is the degradation-detection-target-disc corrected signal quality information M. To perform the correction of the previous degradation-detection target disc, the signal-quality-information correction section 111 stores the corrected degradation-detection-target-disc corrected signal quality information in the signal-quality-information storage section 112.

In Step S902, it has been determined whether or not the difference between the reference-disc measured signal quality information and the reference-disc comparatively estimated signal quality information is not less than the predetermined value. However, the determination is not limited thereto and it is sufficient as long as it can be determined whether or not the detection of the device-caused variation is affected. For example, it may also be possible to determine whether or not the difference between a value obtained by squaring the reference-disc measured signal quality information and a value obtained by squaring the reference-disc comparatively estimated signal quality information is not less than a predetermined value. That is, it may also be possible to determine whether or not the variation between the linearized reference-disc measured signal quality information and the linearized reference-disc comparatively estimated signal quality information is not less than a predetermined value.

Next, a description will be given of a re-correction method for the previous signal quality information of the degradation-detection target disc in Step S903. Here, the previous signal quality information of the degradation-detection target disc corresponds to the degradation-detection-target-disc corrected signal quality information as the post-correction signal quality and is stored in the signal-quality-information storage section 112.

When it is assumed that the previous degradation-detection-target-disc corrected signal quality information is Mp, the degradation-detection-target-disc measured signal quality information is Mm, reference-disc estimated signal quality information calculated using the immediately previous interpolation formula is Mk, and the reference signal quality information of the reference disc is Mi, Mp is given by Numerical Expression (8).

[Numerical Expression 8]

Mp=\sqrt{Mm²−Mk²+Mi²} (8)

Accordingly, when it is assumed that reference-disc estimated signal quality information calculated using a new interpolation formula re-calculated on the basis of the reference-disc measured signal quality information obtained by the most recent measurement is Mn, the post-correction degradation-detection-target-disc corrected signal quality information M is given by Numerical Expression (9).

$$\begin{matrix}[ Numerical Expression 9 ] & \\ \begin{matrix}M = \sqrt{{Mm}^{2} - {Mn}^{2} + {Mi}^{2}} \\ = \sqrt{( {Mm}^{2} - {Mk}^{2} + {Mi}^{2} ) + {Mk}^{2} - {Mn}^{2}} \\ = \sqrt{{Mp}^{2} + {Mk}^{2} - {Mn}^{2}}\end{matrix} & ( 9 )\end{matrix}$$

That is, using the previous degradation-detection-target-disc corrected signal quality information Mp, the reference-disc estimated signal quality information Mk calculated using the immediately previous interpolation formula, and the reference-disc estimated signal quality information Mn calculated using the new interpolation formula re-calculated in Step S603 on the basis of the most recently measured reference-disc signal quality information, the previous degradation-detection-target-disc corrected signal quality information can be re-corrected.

As has been described heretofore, in the present embodiment, when the difference between the reference-disc measured signal quality information and the reference-disc comparatively estimated signal quality information is not less than the predetermined value in Step S902, the interpolation formula used to calculate the reference-disc estimated signal quality information is updated to the interpolation formula with a smaller error using the reference-disc measured signal quality information that has been measured most recently. As a result, it is possible to precisely detect the device-caused variation and precisely correct the signal quality information.

In addition, by re-correcting the previous signal quality information of the degradation-detection target disc having a large error in Step S903, the previous signal quality information can be corrected to more precise signal quality information. By using the re-corrected signal quality information to detect the degradation of the optical disc or predict the lifetime thereof, more precise degradation detection or lifetime prediction can be performed for the optical disc.

When, in Step S902, the difference between the reference-disc measured signal quality information and the reference-disc comparatively estimated signal quality information is not less than the predetermined value, the interpolation formula is not re-calculated. This allows omission of the process of obtaining the interpolation formula and reductions in the time required for the re-correction process and the load resulting therefrom.

The degradation-detection-target-disc corrected signal quality information to be re-corrected may be all the degradation-detection-target-disc corrected signal information items stored in the signal-quality-information storage section 112. However, when all the degradation-detection-target-disc corrected signal information items stored in the signal-quality-information storage section 112 are re-corrected, the process of performing the re-correction requires time to press the process of recording/reproducing user data as the inherent process.

On the other hand, in the present embodiment, the determination process in Step S902 is performed every time a measurement is performed on the reference disc. Accordingly, when the immediately previous measurement was performed on the reference disc, the signal quality information obtained before the immediately previous measurement had been re-corrected. Therefore, it is sufficient to correct only the degradation-detection-target-disc corrected signal quality information that has been corrected between the immediately previous measurement on the reference disc and the most recent measurement on the reference disc. As a result, it is possible to reduce the time required for the correction process and the load on the drive device 101a and precisely correct the signal quality information.

In the present embodiment, it has been assumed that, in Step 903 after the calculation of the interpolation formula in Step 603, the previous signal quality information of the degradation-detection target disc is re-corrected. However, it is sufficient to correct the previous signal quality information of the degradation-detection target disc before the signal quality information of the degradation-detection target disc is used for the lifetime prediction therefor or the like and the time for the re-correction is not limited thereto. For example, the re-correction of the previous signal quality information of the degradation-detection target disc may also be performed after the signal quality information of the degradation-detection target disc is corrected in Step S904. This allows early correction of the signal quality information of the degradation-detection target disc measured in Step S204. Alternatively, the re-correction of the previous signal quality information of the degradation-detection target disc may also be performed when the drive device 101a is not performing recording or reproduction. This allows the correction to be performed without affecting the recording/reproduction process in the drive device 101a and without degrading the convenience of the user.

As has been described heretofore, when the correction method in the information reproduction unit in the present embodiment is used, in the case where the difference between the reference-disc measured signal quality information and the reference-disc comparatively estimated signal quality information is not less than the predetermined value, the interpolation formula used to calculate the reference-disc estimated signal quality information is updated to the interpolation formula with a smaller error using the reference-disc measured signal quality information that has been measured most recently. As a result, it is possible to precisely detect the device-caused variation and precisely correct the signal quality information.

In addition, by re-correcting the previous signal quality information of the degradation-detection target disc having a large error, the previous signal quality information can be corrected to more precise signal quality information. By using the re-corrected signal quality information to detect the degradation of the optical disc or predict the lifetime thereof, more precise degradation detection or lifetime prediction can be performed for the optical disc.

When the difference between the reference-disc measured signal quality information and the reference-disc comparatively estimated signal quality information is not less than the predetermine value, the interpolation formula is not re-calculated. Therefore, it is possible to omit the process of obtaining the interpolation formula and reduce the time required for the correction process and the load resulting therefrom.

### Embodiment 4

In Embodiment 2 described above, the signal quality information of the degradation-detection target disc is measured and corrected in the drive control section 107a of the drive device 101a. Accordingly, when the degradation-detection target disc is subjected to measurement and correction, a load may be placed on the process in the drive control section 107a. Since the drive control section 107a performs the process of recording/reproducing user data to/from the optical disc 114, the placement of the load on the process in the drive control section 107a may affect the process of recording/reproducing user data as the inherent process to reduce the access speed and the convenience of the user.

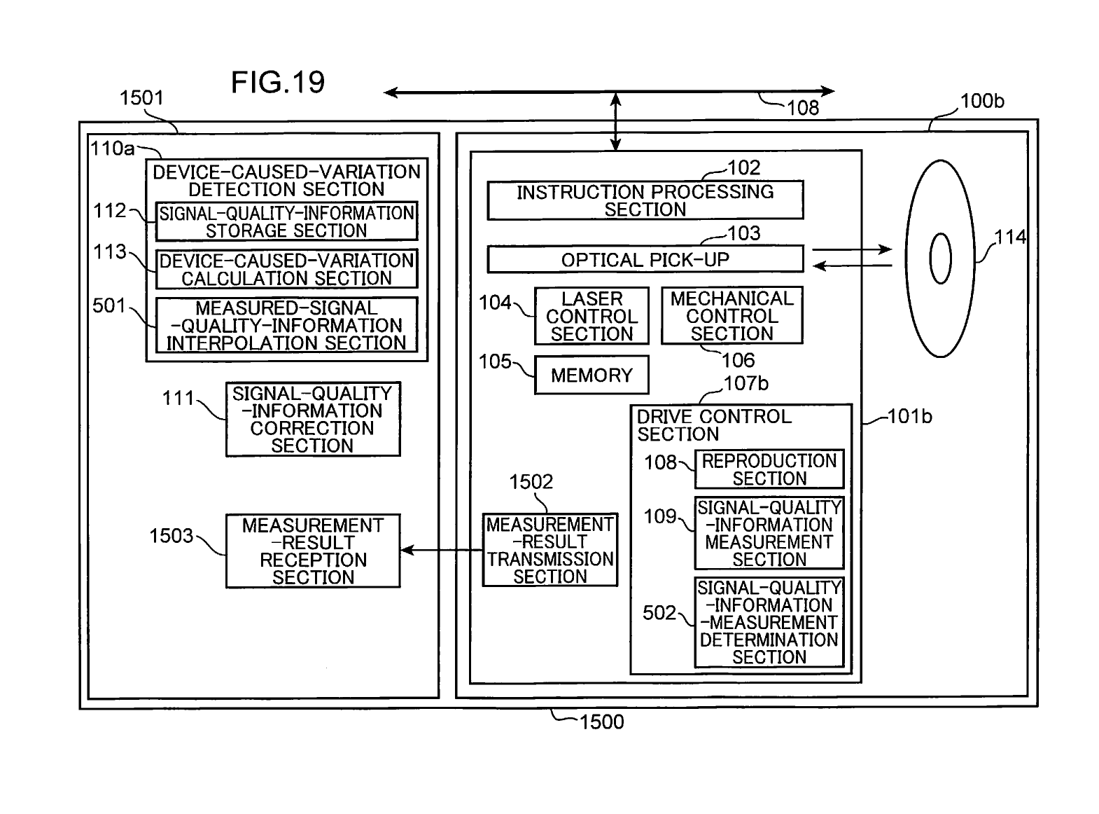

To prevent this, in Embodiment 4, a description will be given of an information reproduction system which reduces the processing time required for correcting signal quality information and the load resulting therefrom. FIG. 19 is a view showing a configuration of the information reproduction system in Embodiment 4 of the present invention. Note that, in FIG. 19, the same components as shown in FIGS. 1 and 11 are designated by the same reference numerals and a repeated detailed description thereof is omitted.

An information reproduction system 1500 shown in FIG. 19 includes an information reproduction unit 100b and a monitoring server 1501. The information reproduction unit 100b and the monitoring server 1501 are connected via a cable such as, e.g., a LAN (Local Area Network) cable or a USB (Universal Serial Bus) cable or a wireless LAN to be capable of data transmission/reception therebetween.

The information reproduction unit 100b includes a drive device 101b, and the optical disc 114. The drive device 101b includes the instruction processing section 102, the optical pick-up 103, the laser control section 104, a memory 105, the mechanical control section 106, a drive control section 107b, and a measurement-result transmission section 1502. The drive control section 107b includes the reproduction section 108, the signal-quality-information measurement section 109 which measures signal quality information, and the signal-quality-information-measurement determination section 502 which determines whether or not a measurement is to be performed on signal quality information. The measurement-result transmission section 1502 transmits the signal quality information measured by the signal-quality-information measurement section 109 to the monitoring server 1501.

The monitoring server 1501 includes the device-caused-variation detection section 110a which detects a device-caused variation, the signal-quality-information correction section 111 which corrects the measured signal quality information, and a measurement-result reception section 1503 which receives the measurement result transmitted from the information reproduction unit 100b. The device-caused-variation detection section 110a includes the signal-quality-information storage section 112, the device-caused-variation calculation section 113, and the measured-signal-quality-information interpolation section 501.

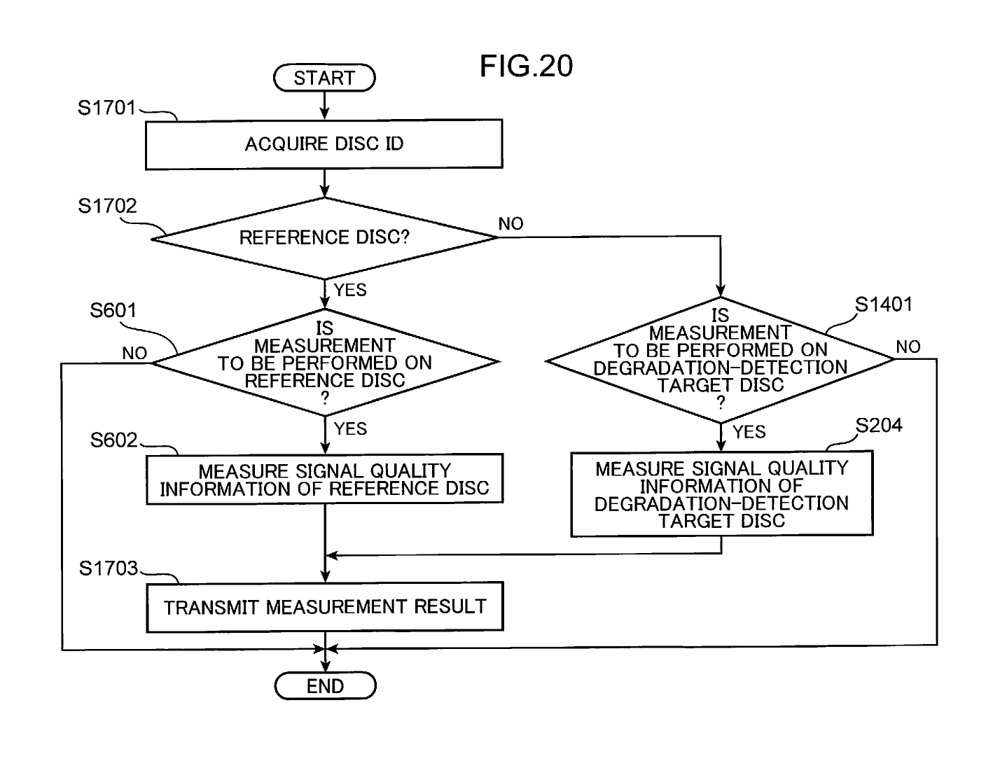

Next, a description will be given of a measurement method for signal quality information in the information reproduction unit 100b. FIG. 20 is a flow chart showing the measurement method for signal quality information in the information reproduction unit 100b in Embodiment 4 of the present invention. Note that, in FIG. 20, the same processes as in FIGS. 6, 12, and 17 are designated by the same reference numerals and a repeated detailed description thereof is omitted.

First, in Step S1701, the signal-quality-information-measurement determination section 502 acquires a disc ID (identification information) as an example of the identifier of an information recording medium. Specifically, the signal-quality-information-measurement determination section 502 performs reproduction from the optical disc attached to the drive device 101b using the reproduction section 108 to acquire the disc ID recorded on the optical disc.

Next, in Step S1702, the signal-quality-information-measurement determination section 502 determines whether or not the optical disc is a reference disc. Specifically, the signal-quality-information-measurement determination section 502 determines, from the disc ID acquired in Step S1701, whether or not the optical disc attached to the drive device 101b is the reference disc.

It is assumed here that the signal-quality-information-measurement determination section 502 has preliminarily held the disc ID of the reference disc in the internal memory thereof. The signal-quality-information-measurement determination section 502 compares the disc ID of the reference disc held therein to the disc ID acquired in Step S1701. When there is a match therebetween, the signal-quality-information-measurement determination section 502 determines that the optical disc is the reference disc and advances to Step S601. When there is no match therebetween, the signal-quality-information-measurement determination section 502 determines that the optical disc is a degradation-detection target disc and advances to Step S1401.

When it is determined in Step S1702 that the optical disc is the reference disc, the signal-quality-information-measurement determination section 502 determines in Step S601 whether or not a predetermined time has elapsed since the immediately previous measurement was performed on the reference disc to determine whether or not a measurement is to be performed on the reference disc. When determining that no measurement is to be performed on the reference disc, the signal-quality-information-measurement determination section 502 ends the process. When the signal-quality-information-measurement determination section 502 determines that a measurement is to be performed on the reference disc, in Step S602, the device-caused-variation detection section 110a measures the signal quality information of the reference disc using the signal-quality-information measurement section 109.

When the signal quality information of the reference disc is measured in Step S602, in Step S1703, the measurement-result transmission section 1502 transmits the measurement result. Specifically, the measurement-result transmission section 1502 transmits the measurement result including the disc ID acquired in Step S1701, the signal quality information of the reference disc measured using the signal-quality-information measurement section 109 in Step S602, and the measurement time at which the measurement was performed to the monitoring server 1401 and ends the process.

On the other hand, when it is determined in Step S1702 that the optical disc is not the reference disc, the signal-quality-information-measurement determination section 502 determines in Step S1401 whether or not the predetermined time has elapsed since the immediately previous measurement was performed on the degradation-detection target disc to determine whether or not a measurement is to be performed on the degradation-detection target disc. When determining that no measurement is to be performed on the degradation-detection target disc, the signal-quality-information-measurement determination section 502 ends the process. When signal-quality-information-measurement determination section 502 determines that a measurement is to be performed on the degradation-detection target disc, in Step S204, the signal-quality-information correction section 111 measures the signal quality information of the degradation-detection target disc using the signal-quality-information measurement section 109.

When the signal quality information of the degradation-detection target disc is measured in Step S204, in Step S1703, the measurement-result transmission section 1502 transmits the measurement result including the disc ID acquired in Step S1701, the signal quality information of the degradation-detection target disc measured in Step S204 using the signal-quality-information measurement section 109, and the measurement time at which the measurement was performed to the monitoring server 1401 and ends the process.

By thus transmitting the disc ID, it is possible to identify the optical disc from which the measured signal quality information has been obtained. The measurement-result transmission section 1502 also transmits the measurement time needed to calculate an interpolation formula or view a change in time degradation.

As described above, the information reproduction unit 100b performs only the measurement of the signal quality information of the reference disc and the degradation-detection target disc and the transmission of the measurement results to the monitoring server 1401 and does not perform the calculation of the device-caused variation or the correction of the signal quality information. Accordingly, it is possible to reduce the load on the process in the information reproduction unit 100b and thus reduce the influence given to the recording/reproduction process. This prevents the access speed from decreasing and impairing the convenience of the user. In addition, since it is sufficient to add the signal-quality-information measurement section 109 which performs the measurement process, the signal-quality-information-measurement determination section 502, and the measurement-result transmission section 1502 which performs the transmission process to the configuration which performs the process of recoding/reproducing user data, the number of the process steps for developing the information reproduction unit 100b can be reduced.

In Step S1702, it has been determined whether or not the optical disc is the reference disc using the disc ID. However, it is sufficient to specify the reference disc using the information which can be acquired from the optical disc and the determination is not limited thereto. For example, the determination may also be performed on the basis of the disc name given by the user or the like. Alternatively, the determination may also be performed on the basis of the name of the manufacturer of the disc. Since the data recorded on the reference disc is known, the determination may also be performed on the basis of the pattern of the recorded data.

In Steps S601 and S1401, it has been determined that a measurement is to be performed when a predetermined time has elapsed from the immediately previous measurement, but the determination is not limited thereto. For example, it may also be possible to receive a measurement instruction from the monitoring server 1501 and determine that a measurement is to be performed when the measurement instruction has been received. As a result, it is sufficient to only determine whether or not the measurement instruction has been received. This can simplify the process in the signal-quality-information-measurement determination section 502.

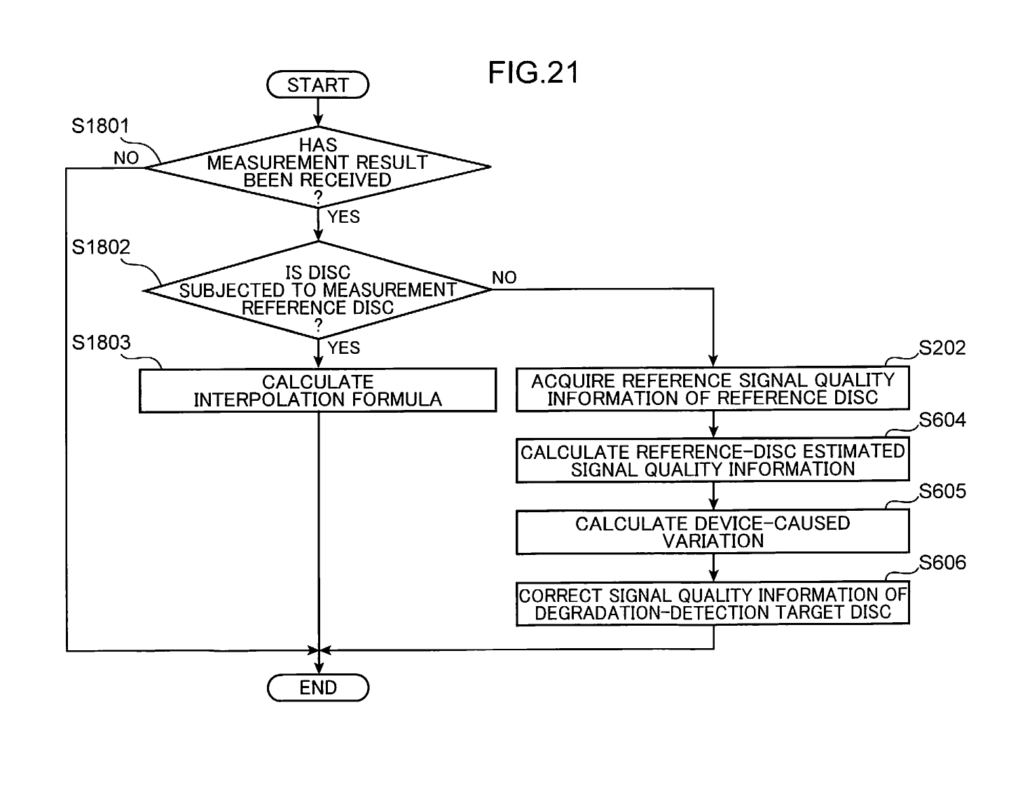

Next, a description will be given of a correction method for signal quality information in the monitoring server 1501. FIG. 21 is a flow chart showing the correction method for signal quality information in the monitoring server 1501 in Embodiment 4 of the present invention. Note that, in FIG. 21, the same processes as in FIGS. 6, 12, and 17 are designated by the same reference numerals and a detailed repeated description thereof is omitted.

First, in Step S1801, the measurement-result reception section 1503 determines whether or not the measurement-result reception section 1503 has received the measurement result. Specifically, the measurement-result reception section 1503 determines whether or not the measurement-result reception section 1503 has received the measurement result transmitted by the measurement-result transmission section 1502. When determining that the measurement-result reception section 1503 has received the measurement result, the measurement-result reception section 1503 stores the result of the measurement on the reference disc or the degradation-detection target disc transmitted by the measurement-result transmission section 1502 in the signal-quality-information storage section 112 and advances to Step S1802. When determining that the measurement-result reception section 1503 has not received the measurement result, the measurement-result reception section 1503 ends the process.

When it is determined in Step S1801 that the measurement result has been received, in Step S1802, the device-caused-variation detection section 110a determines whether or not the optical disc subjected to the measurement is a reference disc. Specifically, the device-caused-variation detection section 110a determines, from the received disc ID, whether or not the optical disc subjected to the measurement is the reference disc.

It is assumed here that the device-caused-variation detection section 110a has preliminarily held the ID of the reference disc in the internal memory thereof. The device-caused-variation detection section 110a compares the disc ID of the reference disc held therein to the received disc ID. When there is a match therebetween, the device-caused-variation detection section 110a determines that the optical disc is the reference disc and advances to Step S1803. When there is no match therebetween, the device-caused-variation detection section 110a determines that the optical disc is the degradation-detection target disc and advances to Step S202.

When it is determined in Step S1802 that the optical disc is the reference disc, in Step S1803, the measured-signal-quality-information interpolation section 501 calculates an interpolation formula. Specifically, the measured-signal-quality-information interpolation section 501 calculates the interpolation formula used to calculate the reference-disc estimated signal quality information Me using the signal quality information and the measurement time that have been received and the previously measured reference-disc measured signal quality information and the previous measurement time that have been stored in the signal-quality-information storage section 112 and ends the process.

On the other hand, when it is determined in Step S1802 that the optical disc is not the reference disc, the device-caused-variation calculation section 113 acquires the reference signal quality information Mi of the reference disc from the signal-quality-information storage section 112 in Step S202. Next, in Step S604, the measured-signal-quality-information interpolation section 501 calculates the reference-disc estimated signal quality information Me using the interpolation formula obtained in Step S1803. Next, in Step S605, the device-caused-variation calculation section 113 calculates the device-caused variation Vc from the reference-disc estimated signal quality information Me calculated in Step S604 and the reference signal quality information Mi of the reference disc acquired in Step S202. Next, in Step S606, the signal-quality-information correction section 111 removes the device-caused variation Vc obtained in Step S605 from the received degradation-detection-target-disc measured signal quality information Mm to correct the degradation-detection-target-disc measured signal quality information Mm, provides the corrected degradation-detection-target-disc measured signal quality information as the degradation-detection-target-disc corrected signal quality information M, and ends the process.

As described above, by performing the correction of the signal quality information at the monitoring server 1501, it is possible to reduce the influence given to the recording/reproduction process in the information reproduction unit 100b. When the interpolation formula or the correction method for signal quality information is changed, it is sufficient to change only the monitoring server 1501 and the information reproduction unit 100b need not be changed. This allows easy change and a reduction in the number of process steps for development.

When a plurality of the information reproduction units are connected to the monitoring server 1501, it is possible to correct the signal quality information of the plurality of degradation-detection target discs attached to the plurality of information reproduction units using the same monitoring server. As a result, it is possible to obtain the signal quality information items of a larger number of degradation-detection target discs. By using the obtained signal quality information items for lifetime prediction, it is possible to perform more precise lifetime prediction. Even when the drive device 101b is replaced, the monitoring server 1501 is not changed and can be used continuously without any trouble.

It has been assumed that the measurement-result reception section 1503 stores the measurement result in the signal-quality-information storage section 112. However, it may also be possible for the measurement-result transmission section 1502 to store the measurement result in the signal-quality-information storage section 112 via the measurement-result reception section 1503. As a result, the measurement-result reception section 1503 need not determine whether or not the measurement-result reception section 1503 has received the measurement result to allow easy processing.

It has also been assumed that the measurement-result transmission section 1502 transmits the measurement result. However, it may also be possible that the information reproduction unit 100b includes the signal-quality-information storage section 112 and the measurement-result reception section 1503 acquires the measurement result from the signal-quality-information storage section 112 present in the information reproduction unit 100b.

In the information reproduction system 1500 in the present embodiment, the information reproduction unit 100b and the monitoring server 1501 are directly connected. However, it may also be possible to connect the monitoring server 1501 and a higher-order device of the information reproduction unit 100b to allow the monitoring server 1501 to receive the measurement result via the higher-order device. As a result, the measurement-result transmission section 1502 of the information reproduction unit 100b is no longer necessary to allow the configuration of the information reproduction unit 100b to be simplified.

The monitoring server 1501 may also notify the user that the optical disc has degraded by e-mail or the like when the signal quality information of the degradation-detection target disc that has been corrected has a value over a predetermined value of, e.g., 15.0% or the like. This allows the user to immediately know that the optical disc has degraded. As a result, it is possible to promptly replace the degraded optical disc and reduce the risk of losing information.

The monitoring server 1501 may also notify the user that the drive device has degraded by e-mail or the like when the signal quality information of the reference disc has a value over a predetermined value of, e.g., 15.0% or the like. This allows the user to immediately know that the drive device has degraded. As a result, it is possible to promptly replace the degraded drive device and reduce the risk of losing information.

The monitoring server 1501 may also send a notification to the user to prompt a measurement on the reference disc when the corrected value of the signal quality information of the degradation-detection target disc is not less than a predetermined value.

As described above, in the information reproduction system in the present embodiment, the correction of the signal quality information of the degradation-detection target disc is performed at the monitoring server 1501 to allow a reduction in the load on the process in the information reproduction unit 100b. This can reduce the influence given to the recording/reproduction process and prevents the access speed from decreasing and impairing the convenience of the user. In addition, when the interpolation formula or the correction method for signal quality information is changed, it is sufficient to change only the monitoring server 1501 and the information reproduction unit 100b need not be changed. This allows easy change and a reduction in the number of process steps for development.

The following is a description of each of the aspects of the present invention given in terms of each of the foregoing embodiments. That is, a signal-quality-information correction device according to one of the aspects of the present invention is a signal-quality-information correction device which corrects signal quality information showing signal quality obtained when an information reproduction device reproduces information from an information recording medium. Measured signal quality information obtained by measuring the signal quality information includes a device-caused variation which is a variation in the signal quality information that has degraded due to the information reproduction device, and a medium-caused variation which is a variation in the signal quality information that has degraded due to the information recording medium. The signal-quality-information correction device includes a device-caused-variation detection section which detects the device-caused variation included in the measured signal quality information, and a signal-quality-information correction section which corrects the measured signal quality information to signal quality information resulting from removal of the device-caused variation detected by the device-caused-variation detection section from the measured signal quality information.

A signal-quality-information correction method according to another of the aspects of the present invention is a signal-quality-information correction method which corrects signal quality information showing signal quality obtained when an information reproduction device reproduces information from an information recording medium. Measured signal quality information obtained by measuring the signal quality information includes a device-caused variation which is a variation in the signal quality information that has degraded due to the information reproduction device, and a medium-caused variation which is a variation in the signal quality information that has degraded due to the information recording medium. The signal-quality-information correction method includes a detection step of detecting the device-caused variation included in the measured signal quality information, and a correction step of correcting the measured signal quality information to signal quality information resulting from removal of the device-caused variation detected in the detection step from the measured signal quality information.

In the signal-quality-information correction device or signal-quality-information correction method described above, by correcting the measured signal quality information that has been measured to the signal quality information from which the device-caused variation has been removed, the degradation of the information recording medium can be correctly detected. In addition, even when the performance of the information reproduction device has changed in such a case where the information reproduction device is replaced, the degradation of the information recording medium can be correctly detected. By further performing degradation detection or lifetime prediction using the corrected signal quality information, correct degradation detection or lifetime prediction can be performed. This can prevent a situation where important data is lost by determining that there is no degradation even though there is actually degradation or information is re-recorded to another optical disc by determining that there is degradation even though there is actually no degradation and such re-recording need not originally be performed, resulting in waste of the information recording media.

It is preferable that the signal-quality-information correction device further includes a reproduction section which reproduces the information from the information recording medium, and a signal-quality-information measurement section which measures, as the measured signal quality information, the signal quality information showing the signal quality obtained when the reproduction section reproduces the information from the information recording medium.

In this case, the signal-quality-information correction device serves as the information reproduction device which reproduces information from the information recording medium and can precisely detect the device-caused variation which is a variation in the signal quality information that has degraded due to the information reproduction device. As a result, the degradation of the information recording medium can be more precisely detected.

It is preferable that the signal-quality-information measurement section measures reference-medium measured signal quality information which is signal quality information of a reference information recording medium having known reference signal quality information, and the device-caused-variation detection section uses the reference signal quality information and the reference-medium measured signal quality information to calculate the device-caused variation.

In this case, since the device-caused variation is calculated using the reference signal quality information of the reference information recording medium and the reference-medium measured signal quality information thereof, the device-caused variation can be precisely detected.

It is preferable that the reference signal quality information is the signal quality information in which the device-caused variation is 0 and the medium-caused variation is known.

In this case, since the device-caused variation is calculated using the reference signal quality information in which the device-caused variation is 0 and the medium-caused variation is known, it is possible to more precisely detect the device-caused variation and correctly detect only the degradation of the information recording medium.

It is preferable that the reference signal quality information is the signal quality information of the reference information recording medium which is measured using a standard evaluation tool.

In this case, the signal quality information of the reference information recording medium can be measured in an optimal state using the standard evaluation tool and the device-caused variation including even an individual difference due to variations in the information reproduction device during the manufacturing thereof can also be detected. Accordingly, the device-caused variation can be more precisely detected.

It is preferable that the signal-quality-information correction device further includes a signal-quality-information-measurement determination section which determines whether or not the reference-medium measured signal quality information is to be measured when the measured signal quality information is corrected, and when the signal-quality-information-measurement determination section determines that the reference-medium measured signal quality information is not to be measured, the device-caused-variation detection section uses the reference-medium measured signal quality information that has been measured previously to estimate reference-medium estimated signal quality information at a time when the measured signal quality information is measured and uses the reference-medium estimated signal quality information and the reference signal quality information to detect the device-caused variation.

In this case, using the reference-medium measured signal quality information that has been measured previously, the reference-medium estimated signal quality information at the time when the measured signal quality information is measured is obtained and, using the reference-medium estimated signal quality information and the reference signal quality information, the device-caused variation is determined. Therefore, it is possible to precisely correct the signal quality information, while reducing the number of times a measurement is performed on the reference information recording medium and reducing the processing time required for correcting the signal quality information and the load resulting therefrom.

It is preferable that the device-caused-variation detection section uses the reference-medium measured signal quality information that has been measured immediately previously as the reference-medium estimated signal quality information and provides, as the medium-caused variation, a total variation in the signal quality information that has degraded after the measurement of the reference-medium measured signal quality information and before the measurement of the measured signal quality information.

In this case, the reference-medium measured signal quality information that has been measured immediately previously is used as the reference-medium estimated signal quality information and the total variation in the signal quality information that has degraded after the measurement of the reference-medium measured signal quality information and before the measurement of the measured signal quality information is provided as the medium-caused variation. Therefore, it is possible to prevent a situation where information is lost by determining that there is no degradation even though the information recording medium has degraded and reliably store the information of the information recording medium.

It is preferable that the device-caused-variation detection section uses an approximation formula for a change with time in the signal quality information of the reference information recording medium that has been obtained in advance by an acceleration test to calculate, as the reference-medium estimated signal quality information, a value of the approximation formula at the time when the measured signal quality information is measured.

In this case, the approximation formula for the change with time in the signal quality information of the reference information recording medium that has been obtained in advance by the acceleration test is used to calculate the value of the approximation formula at the time when the measured signal quality information is measured as the reference-medium estimated signal quality information. This eliminates the need to obtain the approximation formula during the correction process and can reduce the correction process. In addition, since the approximation formula obtained in advance shows an actual change with time, more precise reference-medium estimated signal quality information can be obtained.

It is preferable that the device-caused-variation detection section includes a measured-signal-quality-information interpolation section which obtains, as an interpolation formula, an approximation formula showing a variation with elapsed time in the reference-medium measured signal quality information and calculates, as the reference-medium estimated signal quality information, a value of the interpolation formula at the time when the measured signal quality information is measured.

In this case, the approximation formula which shows the variation with elapsed time in the reference-medium measured signal quality information is obtained as the interpolation formula and, using the reference-medium estimated signal quality information obtained using the interpolation formula and the reference signal quality information, the device-caused variation is determined. Therefore, it is possible to precisely correct the signal quality information, while reducing the number of times a measurement is performed on the reference information recording medium and reducing the processing time required for correcting the signal quality information and the load resulting therefrom.

It is preferable that the measured-signal-quality-information interpolation section provides, as comparatively estimated reference signal quality information, the value of the interpolation formula at a time when the reference-medium measured signal quality information is measured using the signal-quality-information measurement section, and updates the interpolation formula using the reference-medium measured signal quality information that has been measured previously when a difference between the reference-medium measured signal quality information and the comparatively estimated reference signal quality information is not less than a predetermined value.

In this case, when the difference between the reference-medium measured signal quality information and the comparatively estimated reference signal quality information is not less than the predetermined value, using the previously measured reference-medium measured signal quality information, the interpolation formula used to calculate the reference-medium estimated signal quality information is updated to the interpolation formula with a small error. Therefore, it is possible to precisely detect the device-caused variation and precisely correct the signal quality information.

It is preferable that, when the interpolation formula is updated, the signal-quality-information correction section uses the updated interpolation formula to re-correct the signal quality information that has been corrected previously.

In this case, since the previously corrected signal quality information with a large error is re-corrected, the signal quality information can be more precisely corrected. In addition, when the difference between the reference-medium measured signal quality information and the comparatively estimated reference signal quality information is less than the predetermined value, the interpolation formula is not re-calculated. This can omit the process of obtaining the interpolation formula and reduce the time required for the correction process and the load resulting therefrom.

An information reproduction system according to still another of the aspects of the present invention includes an information reproduction unit, and a monitoring server. The information reproduction unit includes the information recording medium, and an information reproduction device which reproduces information from the information recording medium. The information reproduction device includes a reproduction section which reproduces the information from the information recording medium, a signal-quality-information measurement section which measures signal quality information showing signal quality obtained when the reproduction section reproduces the information from the information recording medium, and a measurement-result transmission section which transmits a measurement result including the signal quality information measured by the signal-quality-information measurement section to the monitoring server. Measured signal quality information which is the signal quality information measured by the signal-quality-information measurement section includes a device-caused variation which is a variation in the signal quality information that has degraded due to the information reproduction device, and a medium-caused variation which is a variation in the signal quality information that has degraded due to the information recording medium. The monitoring server includes a measurement-result reception section which receives the measurement result transmitted from the measurement-result transmission section and including the measured signal quality information, a device-caused-variation detection section which detects the device-caused variation included in the measured signal quality information received by the measurement-result reception section, and a signal-quality-information correction section which corrects the measured signal quality information to signal quality information resulting from removal of the device-caused variation detected by the device-caused-variation detection section from the measured signal quality information.

In the information reproduction system, the monitoring server corrects the signal quality information. As a result, it is possible to not only achieve the effects described above, but also reduce the influence given to the recording/reproduction process in the information reproduction unit. In addition, when the correction method for signal quality information or the like is changed, it is sufficient to change only the configuration of the monitoring server and the configuration of the information reproduction unit need not be changed. This allows easy change of the information reproduction system and a reduction in the number of process steps for development.

It is preferable that the measurement result further includes an identifier of the information recording medium. In this case, it is possible to identify the information recording medium from which the measured signal quality information has been obtained.

### INDUSTRIAL APPLICABILITY

The signal-quality-information correction device according to the present invention has the function of being able to precisely detect the degradation of the information recording medium and can prevent the dissipation of the data recorded by a user. Therefore, the signal-quality-information correction device is useful as an optical disc drive device having improved reliability or the like. The signal-quality-information correction device can also be applied to a use as an archive device using an information recording medium or the like.

1-14. (canceled)

15. A signal-quality-information correction device which corrects signal quality information showing signal quality obtained when an information reproduction device reproduces information from an information recording medium, wherein
measured signal quality information obtained by measuring the signal quality information includes:
a device-caused variation which is a variation in the signal quality information that has degraded due to the information reproduction device; and
a medium-caused variation which is a variation in the signal quality information that has degraded due to the information recording medium,
the signal-quality-information correction device comprising:
a device-caused-variation detection section which detects the device-caused variation included in the measured signal quality information;
a signal-quality-information correction section which corrects the measured signal quality information to signal quality information resulting from removal of the device-caused variation detected by the device-caused-variation detection section from the measured signal quality information;
a reproduction section which reproduces the information from the information recording medium; and
a signal-quality-information measurement section which measures, as the measured signal quality information, the signal quality information showing the signal quality obtained when the reproduction section reproduces the information from the information recording medium, wherein
the signal-quality-information measurement section measures reference-medium measured signal quality information which is signal quality information of a reference information recording medium having known reference signal quality information, and
the device-caused-variation detection section uses the reference signal quality information and the reference-medium measured signal quality information to calculate the device-caused variation,
the signal-quality-information correction device further comprising:
a signal-quality-information-measurement determination section which determines whether or not the reference-medium measured signal quality information is to be measured when the measured signal quality information is corrected, wherein
when the signal-quality-information-measurement determination section determines that the reference-medium measured signal quality information is not to be measured, the device-caused-variation detection section uses the reference-medium measured signal quality information that has been measured previously to estimate reference-medium estimated signal quality information at a time when the measured signal quality information is measured and uses the reference-medium estimated signal quality information and the reference signal quality information to detect the device-caused variation.

16. The signal-quality-information correction device according to claim 15, wherein the device-caused-variation detection section uses the reference-medium measured signal quality information that has been measured immediately previously as the reference-medium estimated signal quality information and provides, as the medium-caused variation, a total variation in the signal quality information that has degraded after the measurement of the reference-medium measured signal quality information and before the measurement of the measured signal quality information.

17. The signal-quality-information correction device according to claim 15, wherein the device-caused-variation detection section uses an approximation formula for a change with time in the signal quality information of the reference information recording medium that has been obtained in advance by an acceleration test to calculate, as the reference-medium estimated signal quality information, a value of the approximation formula at the time when the measured signal quality information is measured.

18. The signal-quality-information correction device according to claim 15, wherein the device-caused-variation detection section includes:
a measured-signal-quality-information interpolation section which obtains, as an interpolation formula, an approximation formula showing a variation with elapsed time in the reference-medium measured signal quality information and calculates, as the reference-medium estimated signal quality information, a value of the interpolation formula at the time when the measured signal quality information is measured.

19. The signal-quality-information correction device according to claim 18, wherein the measured-signal-quality-information interpolation section provides, as comparatively estimated reference signal quality information, the value of the interpolation formula at a time when the reference-medium measured signal quality information is measured using the signal-quality-information measurement section, and updates the interpolation formula using the reference-medium measured signal quality information that has been measured previously when a difference between the reference-medium measured signal quality information and the comparatively estimated reference signal quality information is not less than a predetermined value.

20. The signal-quality-information correction device according to claim 19, wherein, when the interpolation formula is updated, the signal-quality-information correction section uses the updated interpolation formula to re-correct the signal quality information that has been corrected previously.

21. A signal-quality-information correction method which corrects signal quality information showing signal quality obtained when an information reproduction device reproduces information from an information recording medium, wherein
measured signal quality information obtained by measuring the signal quality information includes:
a device-caused variation which is a variation in the signal quality information that has degraded due to the information reproduction device; and
a medium-caused variation which is a variation in the signal quality information that has degraded due to the information recording medium,
the signal-quality-information correction method comprising:
a detection step of detecting the device-caused variation included in the measured signal quality information;
a correction step of correcting the measured signal quality information to signal quality information resulting from removal of the device-caused variation detected in the detection step from the measured signal quality information;
a reproduction step of reproducing the information from the information recording medium; and
a measurement step of measuring, as the measured signal quality information, the signal quality information showing the signal quality obtained when the information is reproduced from the information recording medium in the reproduction step, wherein
the measurement step includes measuring reference-medium measured signal quality information which is signal quality information of a reference information recording medium having known reference signal quality information, and
the detection step includes using the reference signal quality information and the reference-medium measured signal quality information to calculate the device-caused variation,
the signal-quality-information correction method further comprising:
a determination step of determining whether or not the reference-medium measured signal quality information is to be measured when the measured signal quality information is corrected, wherein
the detection step includes using, when it is determined in the determination step that the reference-medium measured signal quality information is not to be measured, the reference-medium measured signal quality information that has been measured previously to estimate reference-medium estimated signal quality information at a time when the measured signal quality information is measured and using the reference-medium estimated signal quality information and the reference signal quality information to detect the device-caused variation.
